(19) United States
(12) Patent Application Publication
(10) Pub. No.: US 2015/0268380 A1
(43) Pub. Date: Sep. 24, 2015

(54) WEIGHING PRECIPITATION GAUGE

(71) Applicant: DAVIS INSTRUMENTS CORPORATION, Hayward, CA (US)

(72) Inventor: RICHARD C. ANDERSON, SAN JOSE, CA (US)

(73) Assignee: DAVIS INSTRUMENTS CORPORATION, HAYWARD, CA (US)

(21) Appl. No.: 14/664,276

(22) Filed: Mar. 20, 2015

Related U.S. Application Data
(60) Provisional application No. 61/969,511, filed on Mar. 24, 2014.

(51) Int. Cl. G01W 1/14; G01F 23/20

(52) U.S. Cl. CPC G01W 1/14; G01F 23/20

(57) ABSTRACT

A rainfall and precipitation gauge, in which the weight of collected fluid is continuously measured and recorded in positive increments in a collection vessel with a force gauge or load cell, and where the fluid is discharged once the collected fluid has reached a certain weight. In particular, the rainfall and precipitation gauge can include an armature which is magnetically coupled to a magnet and provides resistance to the weight of collected fluid. The weight of the collected fluid, once sufficient or beyond a threshold, can constitute a force in opposition to the magnetic attractive force and cause the collection vessel to pivot from a collection and measurement position to a fluid discharge position.

### CROSS-REFERENCE TO RELATED APPLICATIONS

The present patent application claims the benefit of priority to U.S. Provisional Patent Application No. 61/969,511 filed on Mar. 24, 2014, which is hereby incorporated by reference.

### FIELD OF THE INVENTION

The present invention generally relates to the field of collecting and measuring rainfall and other precipitation with a self-emptying precipitation gauge. More specifically, embodiments of the present invention are directed to a precipitation gauge apparatus for measuring rainfall based on weight as the rain is collected.

### BACKGROUND OF THE INVENTION

Instruments and apparatus systems that are used for collecting and measuring rainfall and the rate of rainfall often require a receiving bucket or cup oriented toward the sky that collects rainfall and other precipitation. For such known instrumentation, concerns for properly measuring and analyzing the collected rainfall and precipitation include the size of the receiving vessel, sensitivity of any coupled sensor, and consistent drainage of collected rain water or other precipitation. Typically, in known rainfall gauge devices, some of which are referred to as “tipping” gauges, a rainfall collector includes a bucket, spoon, or cup apparatus that accumulates a volume of rainwater and then tips, signaling that a known amount of rain has fallen. However, in such instrumentation, errors may be generated simply due to the physical construction and operation of the rain gauge.

Accordingly, there remains a need to provide rain gauge instrumentation that accurately measures rainfall without errors associated with the physical construction and operation of tipping bucket rain gauges known in the field.

### SUMMARY OF THE INVENTION

The following presents a simplified summary of some embodiments of the invention in order to provide a basic understanding of the invention. This summary is not an extensive overview of the invention. It is not intended to identify key or critical elements of the invention or to delineate the scope of the invention. Its sole purpose is to present some embodiments of the invention in a simplified form as a prelude to the more detailed description that is presented later.

Embodiments of the invention are directed toward a precipitation gauge that includes a base assembly; a base adaptor coupled to the base assembly; a collection vessel having a collection arm and a counterweight arm configured to receive fluid in the collection arm, mounted to the base adaptor via a pivot rod, and operable between a collection and measurement position and a fluid discharge position; a magnet located on the collection arm; an armature configured to magnetically couple to the magnet and hold the collection vessel in the collection and measurement position; and a load cell electrically coupled to the armature and configured to transmit signals corresponding to tension on the armature. The precipitation gauge collection arm can be configured to collect fluid where the collection vessel is oriented at the collection and measurement position, where an increase in weight of the collection vessel due to the collected fluid increases tension on the armature. The weight of the collection arm and fluid held in the collection arm can exerts a torque around the pivot rod greater than the combination of an opposing torque the counterweight arm exerts around the pivot rod and an attractive force of the magnetic coupling between the armature and magnet, such that the collection vessel rotates around a rotational axis of the pivot rod to the fluid discharge position. In some aspects, the torque the counterweight arm exerts around the pivot rod is greater than the torque the collection arm collection arm exerts around the pivot, such that the collection vessel rotates around a rotational axis of the pivot rod to the collection and measurement position. The precipitation gauge can further include a housing above and around the base assembly and base adaptor, configured to receive precipitation and direct fluid into the collection vessel. The precipitation gauge can further include a debris filter mounted within the housing configured to prevent detritus from falling onto the precipitation gauge. The housing can have an opening configured to have a shape and area to regulate the amount of precipitation directed toward the collection vessel. The precipitation gauge can further include a non-transitory computer-readable medium (such as a microprocessor) that is electrically connected with the load cell, that is configured to receive, store, and transmit data corresponding to the signals transmitted by the load cell. The precipitation gauge load cell can transmit signals proportional to increases in tension on the armature, where the increase in tension on the armature can be generated by increases in weight due to fluid collected in the collection arm to which the armature is magnetically coupled via the magnet. Further, the precipitation gauge can be collection vessel is symmetric, such that the lever arm length of precipitation remains constant as precipitation accumulated in the collection vessel.

Embodiments of the invention are directed to a method of measuring precipitation including collecting precipitation in a collection vessel in a collection and measurement position; sensing a tensile force caused by the weight of precipitation collected with at least one load cell coupled to the collection vessel; correlating the tensile force sensed by the at least one load cell with a precipitation measurement; discharging precipitation collected in the collection vessel once a threshold volume of precipitation has been collected by pivoting the collection vessel to a fluid discharge position; and returning the collection vessel to the collection and measurement position. In some aspects of the method, correlating the tensile force sensed by at least one load cell can include sensing positive increments in weight. In other aspects of the method, correlating the tensile force sensed by at least one load cell can include not sensing negative increments in weight. Where at least one load cell is coupled to an armature, and where the armature is configured to magnetically couple with a magnet on a collection arm of the collection vessel, precipitation collected in the collection arm can increase tension on the load call via the armature magnetically coupled to the magnet. In some aspects, the collection vessel can be positioned within a housing, where the housing having an opening with a shape and an area regulating the amount of precipitation collected by the collection vessel. In other aspects of the method, at least one load cell can relay data corresponding to the weight of precipitation to a microprocessor to calculate a precipitation measurement. A counterweight arm of the collection vessel can provide torque, urging the collection vessel toward the collection and measurement position. Precipitation discharged from the collection vessel can be directed toward a drain positioned below the collection vessel. Further, after discharging precipitation, the microprocessor can re-zero the measurement of the weight of precipitation in the collection vessel.

Embodiments of the present invention are directed to a precipitation gauge including a collection vessel which is coupled to a pivot mount via a mounting shaft, mounting rod, or pivot shaft, where the collection vessel has a collection arm and a resistance arm positioned on opposing sides of the pivot mount, the collection vessel being movable between a first position and a second position, the collection vessel further having an armature counterweight mechanically coupled to the end of the resistance arm distal from the pivot mount, a force gauge capable of sensing and signaling compressive and tensile forces, and a magnet mechanically coupled to the force gauge magnetically coupled with the armature counterweight. When the collection vessel is in the first position, the collection arm receives and holds fluids that are received from above the collection vessel, and the armature counterweight is held in close proximity to, or in contact with, the magnet. As the collection arm receives and holds increasing amounts of fluid, the force gauge senses increases in weight through compressive and tensile forces transmitted from the collection arm through the receiving arm and magnet. When the weight of the fluid held by the collection arm exerts or generates sufficient or threshold torque, the magnetic coupling of the magnet and armature counterweight does not hold the magnet and armature counterweight in close proximity, and the collection vessel rotates along a rotational axis of the pivot shaft to the second position such that fluid held within the collection arm is discharged.

Further embodiments of the precipitation gauge include a collection vessel which is coupled to a gauge frame via a pivot shaft (which may be alternatively referred to as a mounting rod or mounting shaft), where the collection vessel has a collection arm and a resistance arm positioned on opposing sides of the pivot shaft, the collection vessel being movable between a first position and a second position, the collection vessel further having an armature counterweight mechanically coupled to the end of the resistance arm distal from the pivot shaft, at least one load cell capable of sensing and signaling compressive and tensile forces, and a magnet mechanically coupled to the gauge frame magnetically coupled with the armature counterweight. When the collection vessel is in the first position, the collection arm receives and holds fluids that are received from above the collection vessel, and the armature counterweight is held in close proximity to, or in contact with, the magnet. As the collection arm receives and holds increasing amounts of fluid, the at least one load cell senses increases in weight through compressive and tensile forces transmitted from the collection arm through the receiving arm and magnet. When the weight of the fluid held by the collection arm exerts or generates sufficient or threshold torque, the magnetic coupling of the magnet and armature counterweight does not hold the magnet and armature counterweight in close proximity, and the collection vessel rotates along a rotational axis of the pivot shaft to the second position such that fluid held within the collection arm is discharged

In some embodiments of the precipitation gauge, following the discharge of fluid from the collection arm, the torque exerted by the armature counterweight and magnet causes the collection vessel to rotate back to the first position. In some aspects, the magnetic attraction between the armature counterweight and magnet causes the collection vessel to rotate back to the first position. In other aspects, when the armature counterweight and magnet are in close proximity, the armature counterweight and magnet are flush and in direct contact with each other. In some embodiments, the force gauge is a cantilever beam gauge.

In some embodiments, the precipitation gauge is contained within a housing above and around the collection vessel which directs fluid into the collection vessel. In many embodiments, a debris filter is mounted within the housing configured to prevent detritus or debris from falling onto the precipitation gauge. In aspects, the precipitation gauge further includes a splash shield configured to prevent fluid collected in the collection arm from splashing onto any other element of the precipitation gauge. In many aspects, the precipitation gauge is coupled to a microprocessor, and can be electrically connected to a microprocessor via a force gauge. In other aspects, the precipitation gauge can be coupled to a microprocessor via at least one load cell.

Alternative embodiments of the precipitation gauge include a collection vessel, coupled to a gauge frame via a pivot shaft, having a collection arm and a resistance arm positioned on opposing sides of the pivot shaft, the collection vessel being movable between a first position and a second position, having a counterweight mechanically coupled to the end of the resistance arm distal from the pivot shaft, an armature positioned in proximity to the end of the collection arm distal from the pivot shaft, the armature being coupled to a force gauge, and a magnet mechanically coupled to the end of the collection arm distal from the pivot shaft, and magnetically coupled with the armature. When the collection vessel is in the first position, the collection arm receives and holds fluids that are received from above the collection vessel, and the armature is held in close proximity to, or in contact with, the magnet. As the collection arm receives and holds increasing amounts of fluid, the force gauge senses increases in weight through compressive and tensile forces transmitted from the collection arm through the magnet. When fluid held by the collection arm exerts or generates sufficient or threshold torque, the magnetic coupling of the magnet and armature does not hold the magnet and armature in close proximity, and the collection vessel rotates along a rotational axis of the pivot shaft to the second position such that fluid held within the collection arm is discharged.

Embodiments of the invention include a method of measuring precipitation rate, where the method includes collecting precipitation in a collection vessel in a collection and measurement position, sensing a compressive or tensile force caused by the weight of precipitation collected with a force gauge and/or at least one load cell coupled to the collection vessel, discharging precipitation collected in the collection vessel once a sufficient or threshold volume of precipitation has been collected by pivoting the collection vessel to a position that discharges the precipitation, and returning the collection vessel to the collection and measurement position. In aspects, the method further includes having a force gauge and/or at least one load cell configured to sense positive increments in weight. In aspects, the method further includes having a force gauge and/or at least one load cell configured to not report negative increments in weight. In embodiments, the measurement of rainfall and other precipitation as it is collected reduces errors typical to other tipping rain gauges known in the field.

These and other features, aspects, and advantages are described below with reference to the following drawings, and will become better understood when the following detailed description is read with reference to the accompanying drawings.

### BRIEF DESCRIPTION OF THE DRAWINGS

FIG. 1 is a side profile cross-sectional schematic of a rain and precipitation gauge collection station, according to aspects and embodiments of the present disclosure.

FIG. 1A is a side profile schematic of a precipitation weight gauge measurement assembly, having a collection vessel coupled to a pivot mount via a pivot shaft, that can be set within a rain and precipitation gauge collection station as shown in FIG. 1, according to aspects and embodiments of the present disclosure.

FIG. 1B is a cross-sectional side elevation schematic of a precipitation weight gauge measurement assembly, where the force gauge is configured in cantilever, according to aspects and embodiments of the present disclosure.

FIG. 1C is a side profile cross-sectional schematic of a precipitation weight gauge measurement assembly, having a collection vessel coupled to a pivot mount via a pivot shaft, in a collection and measurement position, according to aspects and embodiments of the present disclosure.

FIG. 1D is a side profile cross-sectional schematic of a precipitation weight gauge measurement assembly, having a collection vessel coupled to a pivot mount via a pivot shaft, in a discharge position, according to aspects and embodiments of the present disclosure.

FIG. 2 is an isometric exploded side profile schematic of a precipitation weight gauge measurement assembly, having a collection vessel coupled to a gauge frame via a pivot shaft, according to aspects and embodiments of the present disclosure.

FIG. 2A is a side profile cross-sectional schematic of a precipitation weight gauge measurement assembly as shown in FIG. 2, in a collection and measurement position.

FIG. 2B is a side profile cross-sectional schematic of a precipitation weight gauge measurement assembly as shown in FIG. 2, in a discharge position.

FIG. 3 is an perspective schematic of a precipitation weight gauge measurement assembly, having a collection vessel coupled to a gauge frame via a pivot shaft, according to aspects and embodiments of the present disclosure.

FIG. 3A is an isometric exploded side profile schematic of a precipitation weight gauge measurement assembly as shown in FIG. 3.

FIG. 3B is a side profile cross-sectional schematic of a precipitation weight gauge measurement assembly as shown in FIG. 3, in a collection and measurement position.

FIG. 3C is a side profile cross-sectional schematic of a precipitation weight gauge measurement assembly as shown in FIG. 3, in a discharge position.

FIGS. 4A and 4B are perspective schematic representations of a precipitation weight gauge collection vessel and related sensor, according to aspects and embodiments of the present disclosure.

FIG. 5A is a perspective schematic of a precipitation weight gauge collection vessel and related sensor, having a collection vessel coupled to a gauge frame via a pivot shaft, according to aspects and embodiments of the present disclosure.

FIG. 5B is a side profile cross-sectional schematic of a precipitation weight gauge collection vessel as shown in FIG. 5A, having the collection vessel in a collection and measurement position.

FIG. 5C is a side profile cross-sectional schematic of a precipitation weight gauge collection vessel as shown in FIG. 5A, having the collection vessel in a discharge position.

FIG. 6A is a side profile cross-sectional schematic of a precipitation weight gauge measurement assembly, in between a collection and measurement position and a fluid discharge position, according to aspects and embodiments of the present disclosure.

FIG. 6B is a perspective schematic of a precipitation weight gauge measurement assembly, according to aspects and embodiments of the present disclosure.

FIG. 7A is a perspective view schematic of a precipitation weight gauge measurement assembly, having a collection vessel mounted on a base adaptor, according to aspects and embodiments of the present disclosure.

FIG. 7B is a cross-sectional schematic of a precipitation weight gauge measurement assembly, having a collection vessel mounted on a base adaptor, according to aspects and embodiments of the present disclosure.

FIG. 7C is a perspective view schematic of a collection vessel mounted on a base adaptor as shown in FIG. 7A.

FIG. 7D is a perspective view schematic of a load cell and armature unit for a precipitation weight gauge measurement assembly, having a base adaptor as shown in FIG. 7A.

FIG. 8A is a side cross-sectional view of an exemplary load cell mounting to a support plate for a collection vessel, according to aspects and embodiments of the present disclosure.

FIG. 8B is a side cross-sectional view of an alternative exemplary load cell mounting to a support plate for a collection vessel, according to aspects and embodiments of the present disclosure.

FIG. 8C is a side cross-sectional view of a further alternative exemplary load cell mounting to a support plate for a collection vessel, according to aspects and embodiments of the present disclosure.

### DETAILED DESCRIPTION OF THE INVENTION

Throughout this description for the purposes of explanation, numerous specific details are set forth in order to provide a thorough understanding of the many embodiments disclosed herein. It will be apparent, however, to one skilled in the art that the many embodiments may be practiced without some of these specific details. In other instances, well-known structures and devices are shown in diagram or schematic form to avoid obscuring the underlying principles of the described embodiments.

While the many embodiments disclosed herein are generally directed to the collection and measurement of rainfall and other precipitation, the weight-based measurement gauge described herein can be used for any application where the regular collection and measurement of fluids and/or fluid flow would be appropriate or advantageous. The inventor herein has recognized sources of error in known precipitation collection and measurement instrumentation. In particular, each tip of a rain collecting bucket has errors associated with (1) variation in the volume at the tipping point of the bucket, (2) incoming water that is not accounted for during the tipping of the bucket, (3) residual water that fails to drain and remains in the bucket thus affecting the next measurement, and (4) residual water that remains in the bucket when rainfall ceases and then evaporates.

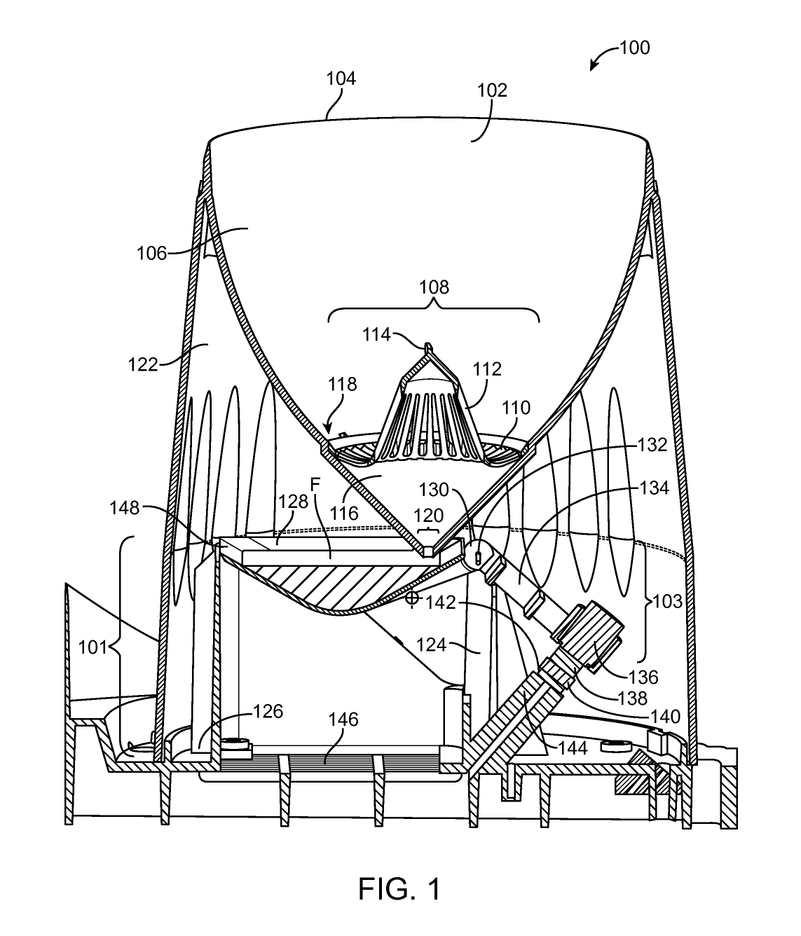

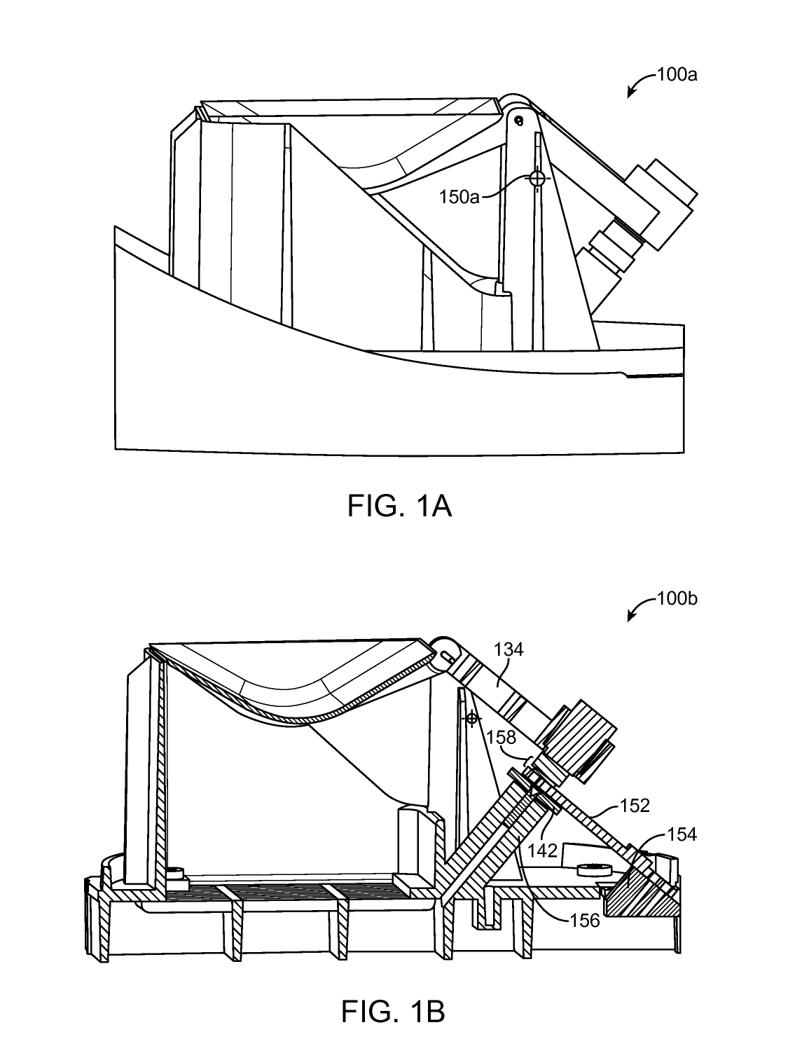

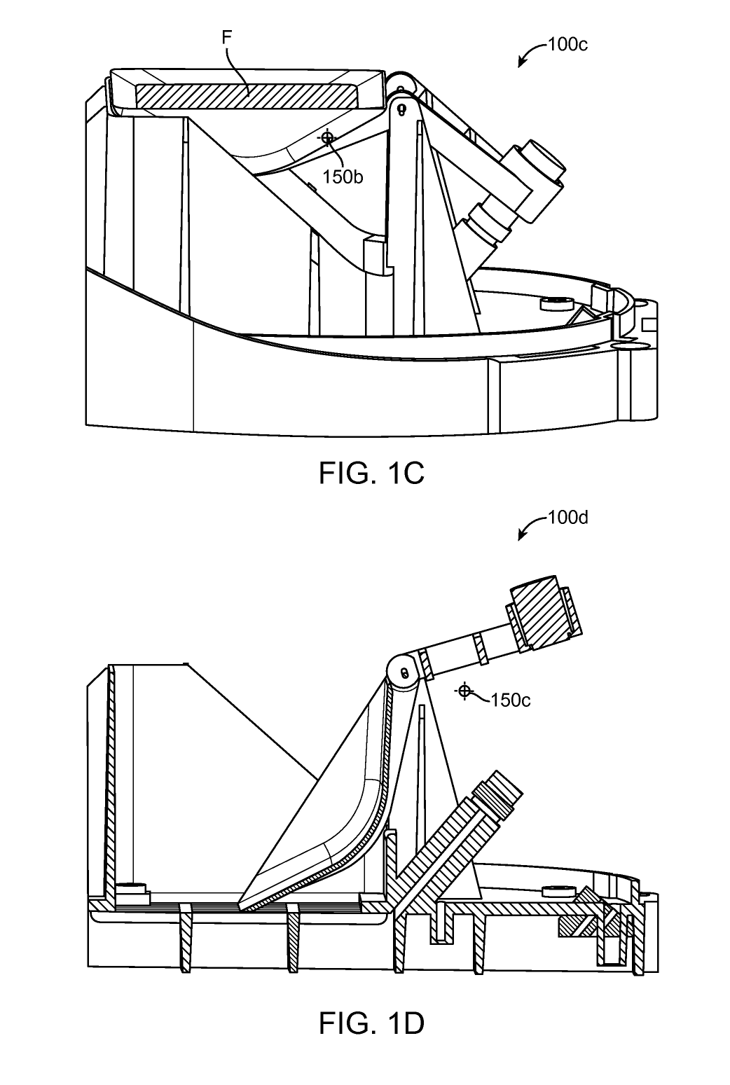

FIG. 1 is a side profile cross-sectional schematic representation of a rain and precipitation gauge collection station 100 according to many embodiments. In particular, FIG. 1 illustrates a rain gauge measuring apparatus housed within a collection station 100 and beneath a collection cone 102. The collection cone 102 is open toward its top so as to be exposed to the environment and to be able to collect rainfall and other precipitation within the collection cone 102. The precipitation opening 104 (also referred to as the capture area) of the collection cone 102 can have an area of about 200 cm², which operates to regulate and standardize the amount of rainfall that is collected by the rain gauge by preventing water from other directions and angles from reaching the gauge, and providing a known area through which rainfall and other precipitation may enter the collection cone 102. In embodiments, the interior walls of the collection cone 102 may be sloped or otherwise shaped to direct rainfall toward the center of the cone and a debris filter 108. The upper interior volume 106 of the collection cone 102 and the lower interior volume 116 of the collection cone 102 may be delineated by the debris filter 108. The debris filter 108 can have a lower filter section 110, an upper filter section 112, and a protrusion 114 for handing and manipulating the debris filter 108. The debris filter 108 (also referred to as a debris screen) is permeable to fluids but can block particulate matter (such as leaves, litter, or other detritus) from passing through the debris filter 108. Thus, the debris filter 108 prevents solid material larger than the pores, holes, or slits of the debris filter 108 from entering the lower interior volume 116. Instead, solid materials are stopped and accumulate on top of the debris screen 108 and remain in the upper interior volume 106 of the collection cone 102. In embodiments, the debris filter 108 has a weight sufficient to prevent becoming dislodged due to physical impact or wind pressures. In some embodiments, the debris filter 108 may secure within the collection cone 102 due to the insertion friction between the debris filter 108 and the interior walls of the collection cone 102. In further embodiments, the debris filter 108 may secure within the collection cone 102 by attaching to a latch or other anchoring device positioned within the collection cone 102.

The debris filter 108 can reside within the interior volume of the collection cone 102 and secure to the interior walls of the collection cone 102 by fitting into and/or resting on a ledge or shelf 118 formed into the interior of the collection cone 102. More specifically, the lower filter section 110 can have a width or diameter that is designed to couple with the ledge 118, and thus rest upon that ledge 118, preventing the debris filter 108 from resting or settling any lower within the collection cone 102 or within the lower interior volume 116 of the collection cone 102. In alternative embodiments, there may be no shelf 118 formed into the interior of the collection cone 102, and the debris filter 108 may simply rest where the diameter of the open area within the collection cone 102 fits and couples with the diameter of the lower filter section 110. The protrusion 114 provides a gripping point that allows an operator to remove, replace, clean, and/or otherwise manipulate the debris filter 108 without adversely affecting the upper filter section 112 or lower filter section 110. Material collected and blocked by the debris filter 108 should be cleaned out and emptied on a regular basis, for proper operation of the gauge.

In alternative embodiments, the debris filter 108 may include engaging members which are configured to couple with and secure to an engagement anchor mounted in the interior of the collection cone 102. In some embodiments, the engagement anchor can be a bar inserted into and extending across the diameter of the collection cone interior. In other embodiments, the engagement anchor can be a groove in the wall of the collection cone 102.

In operation, rainfall or other precipitation that enters the collection cone 102 and the upper interior volume 106 through the precipitation opening 104 is funneled to and passes through the debris filter 108 into the lower interior volume 116. The precipitation fluid is then directed by the walls of the lower interior volume 116 of the collection cone 102 to a delivery port 120, which is an opening at the base of the collection cone 102. Accordingly, the size of pores, holes, or slits of the grate of the debris filter 108 should be smaller than the size of the delivery port 120 opening or orifice. Fluid falls from the delivery port 120 out of the collection cone 102 volume and into the internal space or volume 122 of the collection station 100. The size of the delivery port 120 may be limited in area to regulate and limit the rate of fluid flowing through the opening from the collection cone 102.

Referring to FIG. 1, the fluid that passes through the delivery port 120 falls onto, and is collected by, the precipitation weight gauge measurement assembly 101 located below the collection cone 102 and delivery port 120. The measurement assembly 101 has a collection vessel 103, a support shaft 124 (alternatively referred to as a pivot mount) to which the collection vessel 103 is pivotally mounted, a splash shield 126 configured to prevent fluid from exiting the area where the collection vessel 103 collects fluid, where the support shaft 124 and splash shield 126 are both physically supported by a support base portion of the collection station 100. In alternative embodiments, the precipitation weight gauge can be an assembly that includes a pivot mount structure, a weight gauge frame, or base adaptor construction, as described herein.

In embodiments, wires (not shown) can connect a sensor to a microprocessor or other controller unit located within the collector. In some embodiments, the connection between the sensor and controller unit can be wireless. The controller unit can be configured to send out a pulse for each positive increment of water, so that to any connected device or observing user the signal received is the same as from a conventional tipping-bucket or similar collector. The controller unit can also send additional data, such as the rate of collection, the absolute weight of water held, the identity of the collector, and other relevant metrics or identification data. The controller can send some of the information, such as precipitation rate or intensity of precipitation, in the form of an analog voltage or current.

The collection vessel 103 is shown to have a collection arm 128 (alternatively referred to as a bucket, spoon, or cup), rotation tabs 130 constituting the center of rotation in the central portion of the collection vessel 103, a pivot shaft 132, and a resistance arm 134. In some aspects, the resistance arm 134 can have, in a position distal from the rotation tabs 130, an “armature counterweight” 136 which is designed to magnetically couple with a magnet 138 (the armature counterweight in this context referring to the single structure that can function as both an armature and a counterweight). In other aspects, the resistance arm 134 may be a solid piece of material, may be a partially hollow framework, or may have more than one arm, depending on the desired weight for the resistance arm 134. The collection vessel 103 has its pivot shaft 132 coupled to, or extending through a hole in, the rotation tabs 130. There can be two rotation tabs 130 along the width of the collection vessel 103, which allows for the pivot shaft 132 to evenly support the collection vessel. The pivot shaft 132 rests within holes or receiving cavities within the pivot mount 124 on either side of the pivot shaft 132. Thus, the collection vessel 103 is mounted on the pivot mount 124 via the pivot shaft 132 and can rotate (i.e. pivot or tip) around the axis defined by the length of the pivot shaft 132, or in other words, around the center of rotation. As shown in FIG. 1, the collection arm 128 is positioned on one side of the rotation tabs 130 and pivot shaft 132 while the resistance arm 134 is positioned on the opposing side of the rotation tabs 130 and pivot shaft 132. The pivot shaft 132 may be generally cylindrical, such that it can rotate within receiving cavities or holes within the pivot mount 124. Fluid (F) that falls from the delivery port 120 is collected in the collection arm 128.

The collection arm 128 can be shaped and/or tapered to have a pour lip 148 toward the end of the collection arm 128 distal from the pivot shaft 132, such that fluid held in the collection arm 128 is directed to flow out of the collection arm 128 via the pour lip 148, when the collection vessel 103 is in a position to discharge fluid held within the collection arm 128. In embodiments, when fluid is collected in the collection arm 128 and/or when fluid is discharged by the collection vessel 103, a splash shield 126 is positioned to partially surround the collection arm 128 such that fluids entering or exiting the collection arm 128 do not cause any fluid that may splash to fall into or onto other elements of the measurement assembly 101 or collection station 100. In particular, the splash shield 126 may have a ridge that is level with an upper rim of the collection arm 128 when the collection vessel 103 is in a fluid collection and measurement position. In some embodiments, the splash shield 126 ridge can be higher than the upper rim of the collection arm 128, and in other embodiments the splash shield 126 ridge can be lower than the upper rim of the collection arm 128. In such embodiments, the splash shield 126 defines an area or volume where the collection arm 128 will tilt or descend into when the collection vessel 103 is in a discharge position. Fluid that is discharged from the collection arm 128 may pass out of the collection station 100 through a drain 146 in the base of the collection station 100. The drain 146 is configured to be the bottom surface below the collection arm 128 surrounded by the splash shield 126.

The resistance arm 134 of the collection vessel 103 can be configured to hold an armature counterweight 136 on the end of the resistance arm 134 distal from the pivot shaft 132. In embodiments, the end of the resistance arm 134 distal from the rotation tabs 130 can be molded to securely hold the armature counterweight 136. The armature counterweight 136 can magnetically couple with a magnet 138, which in turn is in physical contact with a force gauge 140. In some embodiments, the armature counterweight 136 and magnet 138 may be held in close proximity to each other, but not necessarily in direct contact, in order to control and regulate the attractive force of the magnetic coupling between the two components. The armature counterweight 136 may be a steel element, or other ferrous component, such that the magnet 138 is magnetically coupled with the armature counterweight 136, and provides resistance to any mechanical force (i.e. torque generated by the weight of the collection arm 128 and any fluid therein) acting on the armature counterweight 136 pulling the armature counterweight 136 in a direction away from the magnet 138. When the armature counterweight 136 and magnet 138 are in physical contact with each other (i.e. when the collection vessel 103 is in a collection and measurement position), the armature counterweight 136 and magnet 138 are shaped to be flush against each other as the magnetic attraction holds the armature counterweight 136 and magnet 138 together. As shown in FIG. 1, the force gauge 140 is positioned and secured on a force gauge support mount 144, where the force gauge support mount is a portion of, or is connected to, the base of the collection station 100. In further embodiments, a primary cushion 142 is located between the force gauge 140 and the force gauge support mount 144. In some embodiments, the force gauge 140 is secured to a mechanical ground. The interaction of the force gauge 140 with the collection vessel 103 is set forth in further detail below.

In one exemplary embodiment, the collection arm 128 can hold an amount of liquid roughly equivalent to about 0.15″ or 4 mm of rainfall or other precipitation. The collection arm 128 can hold a volume of rainfall or other precipitation of about sixty-five to ninety milliliters (65 mL-90 mL). In some embodiments, the collection arm 128 can hold a volume of rainfall or other precipitation of about one hundred eighty milliliters (180 mL). In some embodiments, the collection arm 128 may hold a volume of up to about two hundred milliliters (200 mL). In particular embodiments, the collection arm 128 may hold a volume of up to about two hundred twenty milliliters (220 mL) while being configured to tip once the volume in the collection arm 128 reaches about one hundred eighty milliliters (180 mL). In various embodiments, the collection arm 128 can hold a volume of fluid greater than or less than the volume and ranges considered above. In many embodiments, the collection arm 128 has a symmetrical shape that can be spoon-like, U-shaped, or V-shaped, such that as fluid fills the collection arm, the center of gravity moves along a vertical direction but not to either side of the line of symmetry of the collection arm 128. Accordingly, the length of the lever arm (or “moment”) of collection fluid does not change. The collection arm 128 and/or pour lip 148 may be further shaped to facilitate a rapid discharge of fluid when the collection vessel 103 is in a fluid discharge position.

During operation, the principal forces acting on the collection vessel 103 as it fills with fluid are the torque (alternatively referred to as leverage) generated by the collected fluid and the force of magnetic attraction between the magnet 138 and armature counterweight 136. The torque that acts on the collection vessel 103 is generated by the weight of the fluid collected in the collection arm 128, where the magnitude of the torque is equal to the weight of the fluid multiplied by the distance (i.e. moment arm) from the center of gravity of the fluid to the center of rotation of the collection vessel 103; as used herein, this is referred to as the “collection arm torque”. The weight of the collection arm 128 can also contribute to the collection arm torque. In many embodiments of the measurement assembly, the center of rotation of the collection vessel 103 is along the axis of the pivot shaft 132. The magnetic attraction between the magnet 138 and armature counterweight 136 acts as a holding force in a direction opposite to the amplitude of the torque around the center of rotation; as used herein, this is referred to as the “resistance arm torque”. The weight of the armature counterweight 136 can also significantly contribute to the resistance arm torque.

FIG. 1A is a side profile schematic representation of a precipitation weight gauge measurement assembly, having a collection vessel coupled to a pivot mount via a pivot shaft, in a collection and measurement position according to many embodiments. In particular, FIG. 1A illustrates a measurement assembly in a collection and measurement position while empty of fluid 100a. When the collection arm 128 of the collection vessel 103 is empty of fluid, the weight of the collection arm 128 generates a collection arm torque that is less than the resistance arm torque resulting from the combined weight of the resistance arm 134, including the weight of the armature counterweight 136, and the force of the magnetic coupling between the armature counterweight 136 and the magnet 138. Thus, when the collection arm 128 is empty of fluid, the collection vessel 103 remains in a collection and measurement position in part because the resistance arm torque is greater than the collection arm torque. The center of gravity of the collection vessel 103 when it is empty 150a (“CG_{E}”) is biased toward the side of the resistance arm 134 and armature counterweight 136. As fluid collects in the collection arm 128 of the collection vessel 103 the collection arm torque increases. In some aspects, the center of gravity of the collection vessel and the fluid it holds moves away from the initial CG_{E} 150a position to be biased toward the side of the collection arm 128.

As shown in FIG. 1, Fluid from the collection cone 102 falls from the delivery port 120 onto the collection arm 128, adding to the weight of fluid held within the collection arm 128 and to the magnitude of the collection arm torque. The force gauge 140 is connected to a microprocessor (not shown) which records signals from the force gauge 140. Force gauges in embodiments of the measurement assemblies can be MEMS or other such appropriate sensors. The magnet 138 on the distal end of the resistance arm 134 can be in physical contact and/or close proximity with the force gauge 140 such that any vibration, tension, compression, or other change in force resulting from the addition of fluid to the collection arm 128 is transmitted through the collection vessel 103, through the resistance arm 134, through the magnet 138, and is sensed by the force gauge 140. The force gauge 140 accordingly detects the tension and/or compression caused by the weight of the water in the collection arm. Thus, the force gauge 140 detects increases in the weight of the fluid held in the collection arm 128 as the fluid is collected.

As vibrations from the collection vessel 103 transmit and exert force on the force gauge 140, or as the collection vessel 103 returns to a measurement and collection position as described below, the force gauge 140 itself may experience damage and/or trauma from the shock of the forces and related movement of the resistance arm 134 and/or armature counterweight 163. Accordingly, in some embodiments, a first cushion 142 may be located below the force gauge 140 to prevent the force gauge 140 from moving too far, or over-travelling, in a direction away from the resistance arm 134 and toward the force gauge support mount 144. In such embodiments, the first cushion 142 may be adjustable in relation to its distance from the force gauge 140. Further, in some embodiments, a second cushion 158 may be located between the force gauge 140 and the magnet 138 to prevent trauma or damage to the force gauge 140 as the resistance arm 134 vibrates or exerts a shock or compressive force onto the force gauge 140. The first cushion 142 can have an area that is less than, equal to, or greater than the surface area of the force gauge support mount 144 on which the first cushion 142 rests. The force gauge support mount 144 further provides a stable reference body for the measurement of force.

FIG. 1B is a cross-sectional side elevation schematic representation of an alternative embodiment of a precipitation weight gauge measurement assembly 100b, having a collection vessel coupled to a pivot mount via a pivot shaft, where the force gauge is configured in cantilever, supported against the base of the collection station. In particular, FIG. 1B illustrates a measurement assembly in a collection and measurement position while empty of fluid. In such embodiments, the force gauge is a cantilever beam gauge 152, a portion of which is positioned beneath the resistance arm 134 and is coupled to the magnet 138, and is supported in that position by a cantilever support 154 on the base of the measurement assembly. The cantilever beam gauge 152, in contact with the magnet 138, senses compressive and tensile forces exerted through and by the resistance arm 134 that act on the magnet 138. Further, in such embodiments, the first cushion 142 may be an adjustable cushion, held and supported by a first cushion mount 156. In embodiments, the primary cushion 142 can have an area that is less than, equal to, or greater than the surface area of the primary cushion mount 156 on which the first cushion 142 rests. In some embodiments, a second cushion 158 can be located in between and in physical contact with the cantilever beam gauge 152 and the magnet 138, which can absorb shock and thereby prevent damage to the cantilever beam gauge 152 if subjected to excessive forces transmitted through the resistance arm 134. In embodiments, the second cushion 158 can have an area that is less than, equal to, or greater than the surface area of the magnet 138. The cantilever beam gauge 152 can further be connected to a mechanical ground 154 through the cantilever support which provides a stable reference body for the measurement of force.

FIG. 1C is an isometric schematic representation of a precipitation weight gauge measurement assembly of FIG. 1A in a collection and measurement position. In particular, FIG. 1C illustrates a measurement assembly in a collection and measurement position while filled with fluid 100c. The collection arm 103 may contain fluid F up to the point of completely filling the collection arm 128 volume. In this state, the weight of the collection arm 128 and fluid F in the collection arm 128 generate a collection arm torque which would lead the collection vessel 103 to tip around its center of rotation in the direction of the splash shield 126. In some aspects, the collection of fluid F would result in a center of gravity of the collection vessel 103 when full (“CG_{F}”) 150b. Accordingly, in this state, the resistance arm 134 is subject to a tension force urging the resistance arm 134 upward and away from the force gauge 140, or in other words, in a direction opposite to the resistance arm torque. However, the resistance arm torque generated from magnetic field and attraction between the armature counterweight 136 and the magnet 138 holds the collection vessel 103 in the measurement and collection position up until the point where the collection arm torque sufficiently exceeds the resistance arm torque. The CG_{F} 150b is, relative to the CG_{E} 150a, is biased more toward the collection arm 128 side of the pivot mount 124.

Once the torque of the fluid F and collection arm 128 sufficiently exceeds the torque of the attractive magnetic force between the armature counterweight 136 and the magnet 138, the negative force (i.e. tension) on the resistance arm 134 and armature counterweight 136 will overcome the strength of the magnetic field coupling the armature counterweight 136 and the magnet 138. Accordingly, the armature counterweight 138 will break free from its physical connection to and/or close proximity with the magnet 138, and the collection vessel 103 will pivot, along the center of rotation defined by the pivot shaft 132 resting on the pivot mount 124, toward the side of the collection arm 128. In an aspect, the amount of fluid F and corresponding weight of the fluid F necessary to generate a collection arm torque sufficient to overcome the resistance arm torque generated by the magnetic attraction between the armature counterweight 136 and the magnet 138 can be an amount of fluid F that completely fills the collection arm 128 volume. In other aspects, the collection arm torque necessary to overcome the resistance arm torque can be generated by an amount of fluid F that only partially fills the collection arm 128 volume. The magnet and armature are configured to separate and allow the collection vessel 103 to pivot and tip before the collection arm 128 fills to the point of fluid F overflowing out of the collection arm 128. In various embodiments, the collection arm 128 can hold a volume of about two hundred milliliters (200 mL) or more. In particular embodiments, the collection arm 128 may hold a volume of up to about two hundred twenty milliliters (220 mL) while being configured to tip once the volume in the collection arm reaches about one hundred eighty milliliters (180 mL). In various embodiments, the collection arm 128 can hold a volume of fluid greater than or less than the volume and ranges considered above. In other words, due to the collection of fluid, the collection arm torque can overcome a threshold force, exceeding the resistance arm torque, at which point the collection vessel 103 can rotate around the axis of rotation defined by the pivot mount 124.

FIG. 1D is a side profile cross-sectional schematic representation of a precipitation weight gauge measurement assembly of FIG. 1A in a fluid discharge position. In particular, FIG. 1D illustrates a measuring assembly where the collection vessel is in a fluid discharge position 100d and thus is empty of any fluid F. When the collection vessel 103 is in the fluid discharge position, where the collection arm 128 has tipped into the volume surrounded by the splash shield 126, and where the resistance arm 134 has raised to a position distal from the force gauge 140, the center of gravity of the collection vessel 103 in the discharge position (“CG_{D}”) 150c is biased toward the resistance arm 134 and armature counterweight 136 side of the collection vessel 103. The CG_{D} 150c is, relative to the CG_{E} 150a, is biased further toward the resistance arm 134 side of the pivot mount 124 when the collection vessel 103 is in the fluid discharge position. As illustrated in FIG. 1D, the fluid F previously held in the collection arm 128 has drained through the drain 146 in the base of the collection station 100. The splash shield 126 is configured to prevent any fluid exiting the collection arm 128 from splashing onto or falling into other elements of the measurement assembly 101 or collection station in which the measurement assembly is housed.

In many embodiments, the collection vessel 103 tips once the weight of the collected fluid F increases collection arm torque sufficiently such that the negative force (tension) on the resistance arm 134 overcomes the resistance arm torque. The weight of the armature counterweight 136 continues to provide a resistance arm torque such that once fluid F is discharged from the collection arm 128, the collection vessel 103 rotates back into a measurement and collection position. In some aspects, the magnetic attraction between the armature counterweight 136 and magnet 138 also contributes to the rotation of collection vessel 103 back into a measurement and collection position. A stream of fluid falling from the delivery port 120 and striking the collection arm 128 exerts a force which resists the return of the collection arm 128 to a collection and measurement position. To limit this force, the diameter of the delivery port 120 can be configured to be made small enough to limit the amplitude of the fluid stream, and the collection arm 128 is positioned such that the delivery port 120 orifice is close to the pivot point of the rotation tabs 130, thus reducing the length of the moment arm of the force. Thus, the collection vessel 103 goes through a periodic cycle of collection and measurement and then discharge. The collection vessel 103 can be designed to pivot and tip, thereby discharging the fluid, before the collection arm 128 overflows. Unlike “tipping bucket’ rainfall gauges known in the art, because the collected fluid F has been measured during its accumulation, the volume at the time of tipping is not significant to record or to base a calculation on for calculating or otherwise determining rainfall or precipitation. Accordingly, any error associated with variation in the volume of fluid F at the tipping point of the bucket, as seen in rain gauges known in the art, does not occur.

In embodiments, the presence of the fluid F collected in the collection vessel 103 is continuously measured and recorded as it is received from the delivery port 120 in the collection arm 128. In such embodiments, measurements are recorded for positive increments of collected fluid weight. Accordingly, when fluid is discharged from the collection vessel 103, as described below, any fluid that fails to drain from the collection arm 128 does not adversely affect or create error in the subsequent collection and measurement of rainfall or precipitation. Rather, the measurement of rainfall or other precipitation is simply based on the sum of the positive increments of fluid F collected between the return of the collection vessel 103 to its collection and measurement position and the next discharge of fluid. In other words, the measurement and recording of weight is zeroed (or re-zeroed) to a new baseline. Thus, error due to remnant or residual fluid, as seen in rain gauges known in the art, is eliminated. Similarly, any remnant or residual fluid in a collection vessel 103 that evaporates after precipitation ceases does not create any error in measurement, because negative incremental changes in weight are ignored and only positive increments of collected fluid weight are the basis for sensing and calculations, thus the microprocessor connected to the force gauge 140 can be configured to not record the decline in weight. Such measurements, configuration, and data processing can be applied with all embodiments of precipitation weight gauge assemblies as disclosed herein.

As considered in the present disclosure, in further contrast with rain tipping gauges known in the art, the volume of fluid that can be held by embodiments of the collection vessel as disclosed herein are greater than the volumes that trigger recording events in known tipping bucket rain gauges. Thus, a collection vessel of the presently-disclosed device may tip to a fluid discharge position less frequently, which depending on the volume of the collection arm, may be five times (5×), fifteen times (15×), thirty times (30×), forty times (40×), or even up to two hundred times (200×) less frequently than tipping bucket rain gauges known in the art. Embodiments of the measurement assembly may collect from about 0.01″ to about 2″ of rainfall or precipitation before discharging the collected fluid. The decreased frequency of fluid discharge thereby reduces the opportunity for errors stemming from missing the measurement of incoming precipitation while the collection vessel is tipping or in the fluid discharge position. Further, any error that does result from rainfall or other precipitation that is missed or not measured during the period the collection vessel is in a fluid discharge position can be corrected for by calculating the precipitation loss based on the measured rate of precipitation and tip duration.

In further embodiments, the resistance arm 134 may be connected to the force gauge 140, or other anchoring point, by a mechanical latch (not shown) in lieu of or in addition to a magnet 138. In such embodiments, the latch may transmit changes in weight to the force gauge 140, and may hold the collection vessel 103 in a measurement and collection position up until the point that the weight of fluid held by the collection arm 128 overcomes the strength of the latch between the resistance arm and the force gauge 140, or between the latch and another anchoring point.

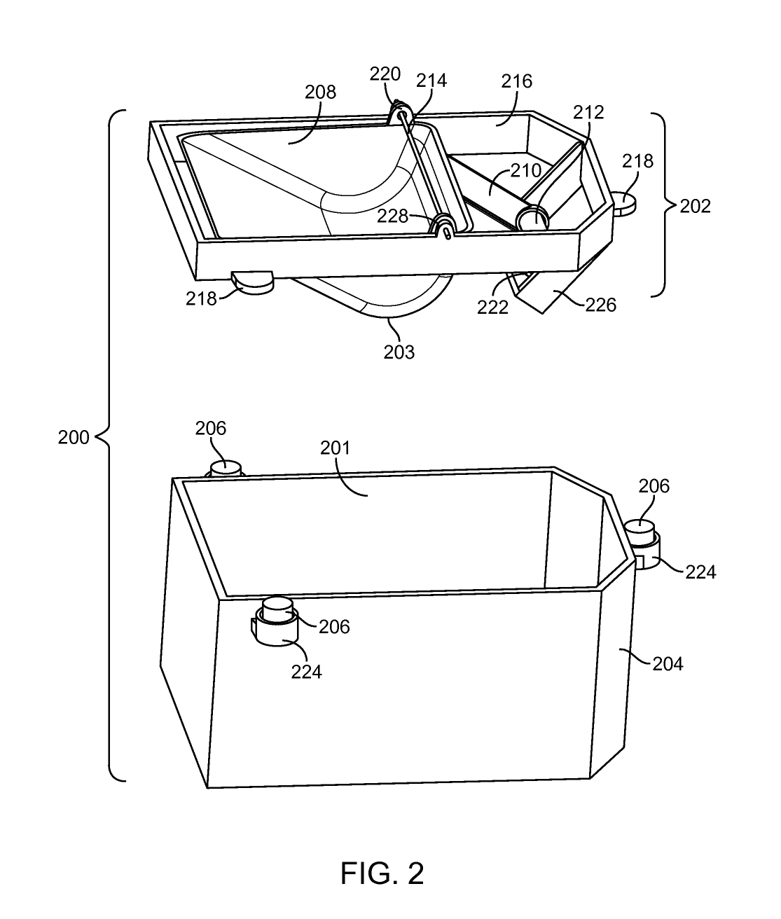

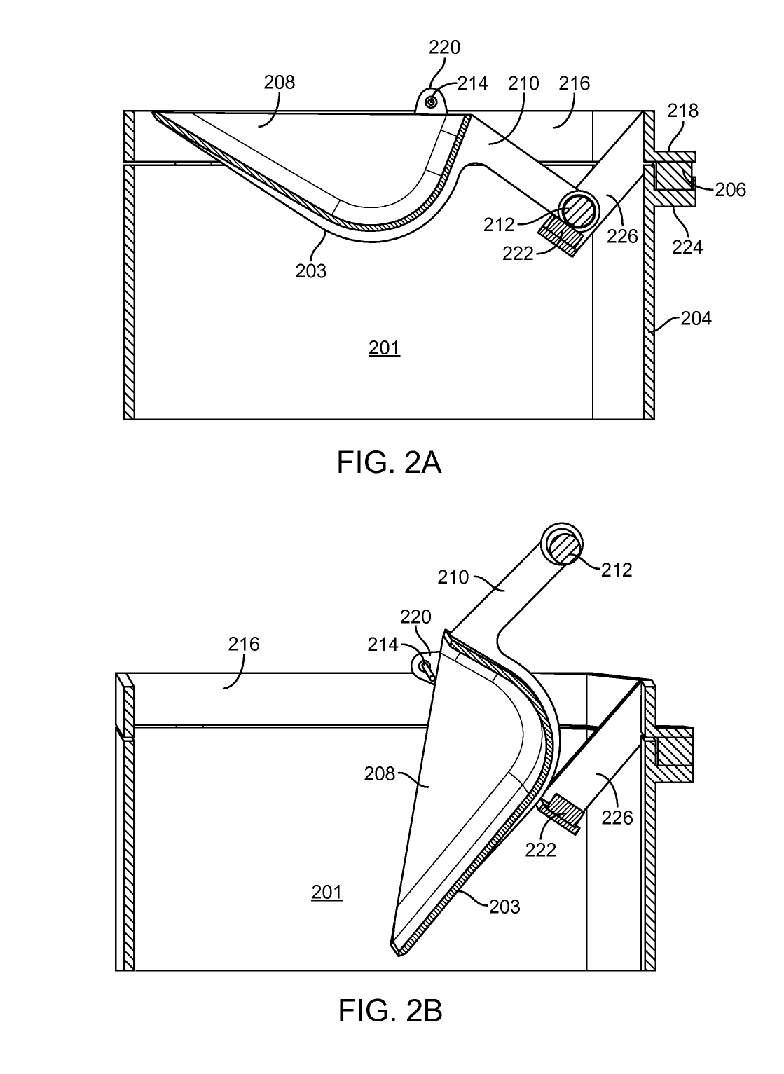

FIG. 2 is an exploded profile schematic representation of a precipitation weight gauge measurement assembly 200, having a collection vessel coupled to a gauge frame via a pivot shaft. In particular, FIG. 2 illustrates an embodiment where the measurement assembly weight gauge 202 rests slightly above a splash enclosure 204 supported on at least one load cell 206. The precipitation gauge measurement assembly 200 can be housed within a rain gauge collection station, and be accordingly positioned beneath a collection cone and delivery port which directs precipitation fluid into the precipitation gauge measurement assembly 200. In embodiments of the measurement assembly, the weight gauge frame 216 has one or more support tabs 218 that extend from the weight gauge frame 216. The support tabs 218 align and match up with one or more load cells 206, held in load cell holsters 224 extending out from the splash enclosure 204. The one or more load cells 206 are transducers that serve the dual purpose of converting a force received through the weight gauge frame 216 into an electrical signal and supporting the measurement assembly weight gauge 202 over the splash enclosure 204. The collection vessel 203 can include a collection arm 208, a resistance arm 210 an armature counterweight 212, and a rotation tab 220. In such embodiments of the precipitation gauge measurement assembly 200, the collection vessel 203 is not coupled to a support shaft or pivot mount directly connected to the base of the overall station. Rather, the collection vessel 203 is suspended by a pivot shaft 214 which extends through holes in the rotation tabs 220, and which further extends through holes, or into a cavity, of mounting tabs 228 which are part of the weight gauge frame 216. The mounting tabs 228 can extend from an upper surface of the weight gauge frame 216. Thus, the collection vessel 203 is suspended on the mounting rod 214 such that the collection vessel 203 can rotate (i.e. pivot or tip) around the axis defined by the length of the pivot shaft 214. The collection arm 208 is positioned on one side of the rotation tabs 220 and pivot shaft 214 while the resistance arm 210 is positioned on the opposing side of the rotation tabs 220 and pivot shaft 214. The pivot shaft 214 can be generally cylindrical, such that it can freely rotate within receiving cavities or holes within the rotation tabs 220 and mounting tabs 228. The precipitation gauge measurement assembly 200 can be housed within a precipitation collection station such that fluid that falls from a delivery port above the precipitation gauge measurement assembly 200 is collected in the collection arm 208.

In some embodiments, the weight gauge frame 216 includes a portion referred to as the magnet frame 226, which can project in a direction downward from the plane in which the weight gauge frame 216 is oriented. The magnet frame 226 can further be configured to carry and support a magnet 222. The armature counterweight 212 mounted at the end of the resistance arm 210 distal from the rotation tabs 220 can be a steel element, or any other ferrous component, and can magnetically couple with the magnet 222. The attractive magnetic force between the armature counterweight 212 and the magnet 222 generates a resistance arm torque that provides resistance to any mechanical force (i.e. collection arm torque generated by the weight of the collection arm 208 and any fluid therein) acting on the armature counterweight 212 pulling the armature counterweight 212 in a direction away from the magnet 222. The resistance arm torque thus operates to hold the collection vessel 203 in a position where the collection arm 208 collects and holds any fluid that drops into the collection arm 208. As the collection arm 208 collects fluid, the compressive force resulting from the increased weight is transmitted through the collection vessel 203 and weight gauge frame 216 to the one or more load cells 206 which then emits a signal that can be measured and used to calculate the increase of fluid. As more fluid is collected, the weight of the fluid increases the collection arm torque acting on the collection vessel 203, pushing the collection arm 208 portion downward into the interior volume 201 of the splash enclosure 204. When the collection arm torque is sufficient to overcome the resistance arm torque, the collection vessel 203 will rotate around the pivot shaft 214 to a fluid discharge position. In other words, due to the collection of fluid, the collection arm torque can overcome a threshold force, exceeding the resistance arm torque, at which point the collection vessel 203 can rotate around the axis of rotation defined by the pivot shaft 214.

The collection arm 208 can, in some aspects, hold an amount of rainfall or other precipitation of about 0.15″ or 4 mm in depth. In terms of volume, the collection arm 208 can hold a volume of rainfall or other precipitation of about sixty-five to ninety milliliters (65 mL-90 mL). In some embodiments, the collection arm 208 can hold a volume of rainfall or other precipitation of about one hundred eighty (180 mL). In alternative embodiments, the collection arm 208 can hold a volume of up to about two hundred milliliters (200 mL) or more. In particular embodiments, the collection arm 128 may hold a volume of up to about two hundred twenty milliliters (220 mL) while being configured to tip once the volume in the collection arm 208 reaches about one hundred eighty milliliters (180 mL). In various embodiments, the collection arm 208 can hold a volume of fluid greater than or less than the volume and ranges considered above. The collection arm 208 may be further shaped to facilitate a rapid discharge of fluid when the collection vessel 203 is in a fluid discharge position. Fluid can pass out of the apparatus through a drain positioned along the bottom surface surrounded by the splash enclosure 204.

FIG. 2A is a side profile cross-sectional schematic representation of a precipitation gauge measurement assembly 200 of FIG. 2 in a collection and measurement position. The weight gauge frame 216 is oriented to have its support tabs 218 resting on top of and aligned with the load cells 206. In such embodiments, there is a space that separates the weight gauge frame 216 from directly resting on the upper ridge of the splash enclosure 204. In this configuration, any compressive and/or tensile force corresponding to an increase of fluid weight to the collection arm 208 will transmit to the load cells 206. In embodiments, the collection arm 208 can have a bucket, cup, U-shape, V-shape, or spoon shape.

FIG. 2B is a side profile cross-sectional schematic representation of a precipitation gauge measurement assembly 200 of FIG. 2 in a fluid discharge position. As illustrated, an amount of fluid had collected in the collection arm 208 of the collection vessel 203 such that the collection arm torque overcame the resistance arm torque generated by magnetic attractive force between the armature counterweight 212 and the magnet 222 resting on the magnet frame 226 and the weight of the armature counterweight 212. The rotation tabs 220 of the collection vessel 203 allowed the collection vessel 203 to rotate around the pivot shaft 214 as the center of rotation for the collection vessel 203. Accordingly, the collection vessel 203 is shown as rotated to a fluid discharge position, where the collection arm 208 is angled such that any fluid held within the collection arm is discharged into the splash enclosure interior volume 201. The splash enclosure 204 is configured completely surround the collection arm 208 when in a fluid discharge position in order to prevent any fluid exiting the collection arm 208 from splashing onto or falling into other elements of the measurement assembly 200 or collection station in which the measurement assembly is housed. In the fluid discharge position, the resistance arm 210 and armature counterweight 212 are raised to a position distal from the magnet 222 and above the horizontal plane in which the weight gauge frame 216 is oriented. Once fluid is discharged from the collection arm 208, resistance arm torque generated by the weight of the resistance arm 210 and armature counterweight 212 causes the collection vessel 203 to rotate back to a collection and measurement position. In some aspects, the magnetic attraction between the magnetically coupled armature counterweight 212 and magnet 222 also contributes to the rotation of collection vessel 203 back to a collection and measurement position.

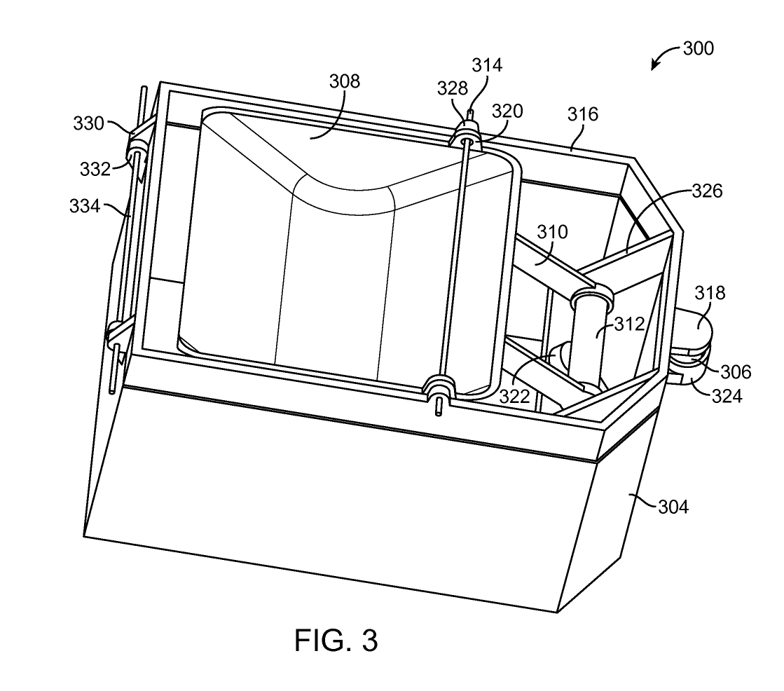

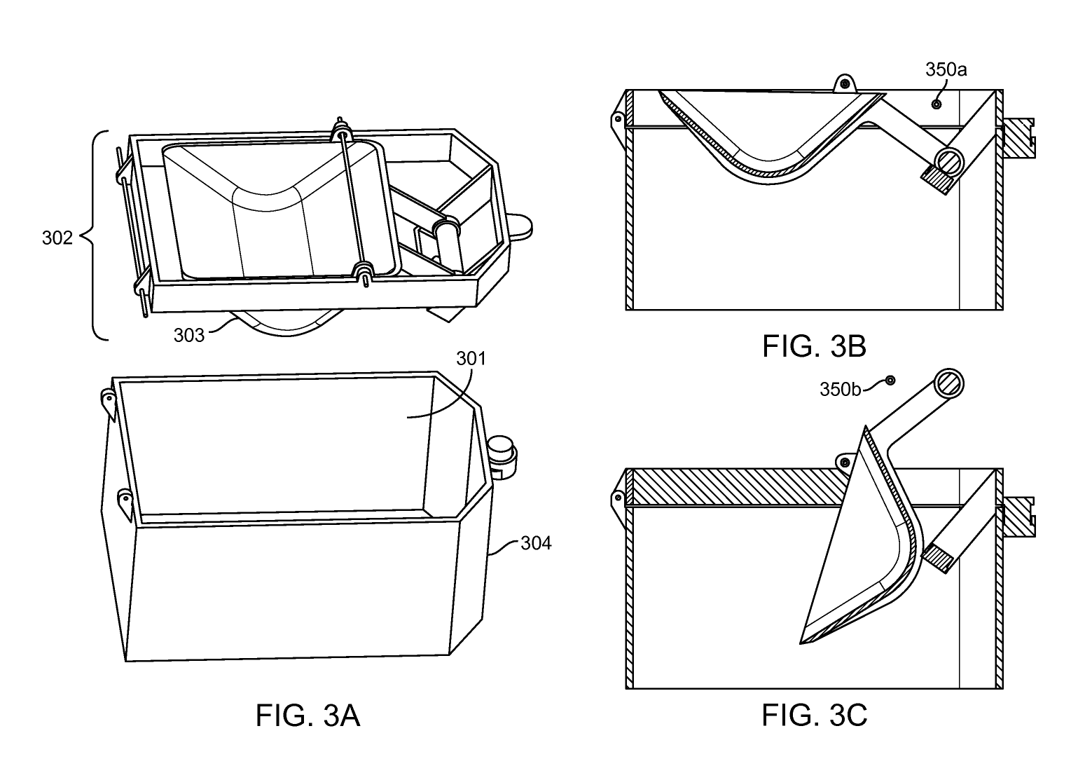

FIG. 3 is a perspective schematic representation of a precipitation weight gauge measurement assembly 300, having a collection vessel coupled to a gauge frame via a pivot shaft 314. In particular, FIG. 3 illustrates an embodiment where the measurement assembly weight gauge 302 rests slightly above a splash enclosure 304 supported on at least one load cell 306. FIG. 3A is an isometric exploded side profile schematic representation of a precipitation gauge measurement assembly as shown in FIG. 3. The precipitation gauge measurement assembly 300 can be housed within a rain gauge collection station, and be accordingly positioned beneath a collection cone and delivery port which directs precipitation fluid into the precipitation gauge measurement assembly 300. In embodiments of the measurement assembly, the weight gauge frame 316 has a horizontal support tab 318 that extends from the weight gauge frame 316. The support tab 318 aligns and matches up with one load cell 306, held in a load cell holster 324 extending out from the splash enclosure 304. The load cell 306 is a transducer that serves the dual purpose of converting a force received through the weight gauge frame 316 into an electrical signal and partially supporting the measurement assembly weight gauge 302 over the splash enclosure 304. In the embodiment as shown in FIG. 3, the weight gauge frame 302 is additionally supported by a weighing support rod 334, which is positioned to extend through support rod mounts 332 projecting from the exterior surface of the splash enclosure 304, and further extends through the vertical support tabs 330 that project from the weight gauge frame 316. The support rod mounts 332 and vertical support tabs 330 are configured to match up and align in order to allow the weighing support rod 334 to pass between holes and/or cavities in the support rod mounts 332 and vertical support tabs 330, allowing the measurement assembly weight gauge 302 to pivot around the axis defined by the length of the weighing support rod 334. This support rod 334 provides for the ability to pivot and move the measurement assembly weight gauge 302, and thereby allows for transfer of a portion of the fluid's weight force to the load cell 306 while maintaining alignment of the weight gauge with the load cell 306. In other words, as precipitation collects in the collection arm 308, the weight gauge frame 316 can rotate around the axis of the weighing support rod 334, directing more force onto the load cell 306, thereby allowing the load cell 306 to measure the incremental increase in weight resulting from the collected precipitation. The degree of rotation around the weighing support rod 334 can be very small, but sufficient to register an increase of force on the load cell 306. Accordingly, when precipitation held within the collection arm 308 is released, the weight gauge frame 316 can rotate away from the load cell 306 back to a position (and force on the load cell 306) indicative of an empty collection arm 308. The ability to pivot and move the measurement assembly weight gauge 302 around the axis of the pivot shaft 314 permits access to the splash enclosure interior space 301 without significantly disrupting alignment of the weight gauge frame 302 with the load cell 306.

In such embodiments, the collection vessel 303 is designed to have a collection arm 308, a resistance arm 310, an armature counterweight 312, and rotation tabs 320. In such embodiments of the precipitation gauge measurement assembly 300, the collection vessel 303 is not coupled to a support shaft or pivot mount directly connected to the base of the overall station. Rather, the collection vessel 303 is suspended by a pivot shaft 314 which extends through holes in the rotation tabs 320, and which further extends through holes, or into a cavity, of mounting tabs 328 which are part of the weight gauge frame 316. The mounting tabs 328 can extend from an upper surface of the weight gauge frame 316 and can be configured to align with the holes of the rotation tabs 320. Thus, the collection vessel 303 is suspended on the pivot shaft 314 such that the collection vessel 303 can rotate (i.e. pivot or tip) around the axis defined by the length of the pivot shaft 314. Further, the weight gauge frame 316 is suspended over the splash enclosure 304 by the load cell 306 and the weighing support rod 334, such that the weight gauge frame 316 can rotate around the axis of the weighing support rod 334. In embodiments, the collection arm 308 is positioned on one side of the rotation tabs 320 and pivot shaft 314 while the resistance arm 310 is positioned on the opposing side of the rotation tabs 320 and pivot shaft 314. The pivot shaft 314 can be generally cylindrical, such that it can freely rotate within receiving cavities or holes within the rotation tabs 320 and mounting tabs 328. Fluid that falls from a delivery port above the precipitation gauge measurement assembly 300 is collected in the collection arm 308.

In this embodiment, the weight gauge frame 316 includes a portion referred to as the magnet frame 326, which can project in a direction downward from the horizontal plane in which the weight gauge frame 316 is oriented. The magnet frame 326 can further be configured to carry and support a magnet 322. The armature counterweight 312 mounted at the end of the resistance arm 310 distal from the rotation tabs 320 can be made of steel, ferrous, or any other magnetically permeable material, and can magnetically couple with the magnet 322. The attractive magnetic force between the armature counterweight 312 and the magnet 322 and weight of the armature counterweight 312 generates a resistance arm torque that operates to hold the collection vessel 303 in a position where the collection arm 308 collects and holds any fluid that drops into the collection arm 308. As the collection arm 308 collects fluid, the compressive and/or tensile force resulting from the increased weight is transmitted through the collection vessel 303 and weight gauge frame 316 to the load cell 306 which then emits a signal that can be measured and used to calculate the increase of fluid. Further, as fluid is collected, the weight of the fluid acts on the collection vessel 303 increases the collection arm torque, pushing the collection arm 308 portion downward into the interior volume 301 of the splash enclosure 304. When the collection arm torque is sufficient to overcome the resistance arm torque, the collection vessel 303 will rotate around the pivot shaft 314 to a fluid discharge position. In other words, due to the collection of fluid, the collection arm torque can overcome a threshold force, exceeding the resistance arm torque, at which point the collection vessel 303 can rotate around the axis of rotation defined by the pivot shaft 314. In some aspects, the armature counterweight 312 can be separate elements, an armature and a counterweight, where the armature is magnetically permeable.

In embodiments, the collection arm 308 can hold an amount of rainfall or other precipitation of about 0.15″ or 4 mm in depth. In terms of volume, the collection arm 308 can hold a volume of rainfall or other precipitation of about sixty-five to ninety milliliters (65 mL-90 mL). In some embodiments, the collection arm 508 can hold a volume of rainfall or other precipitation of about one hundred eighty (180 mL). In alternative embodiments, the collection arm 308 may hold a volume of up to about two hundred milliliters (200 mL) or more. In many embodiments, the collection arm 308 has a symmetrical shape that can be spoon-like, U-shaped, or V-shaped, such that as fluid fills the collection arm, the center of gravity moves along a vertical direction but not to either side of the line of symmetry of the collection arm 308. Accordingly, the length of the lever arm of the collection fluid does not change, and length measurements are linear with the volume of collected precipitation. The collection arm 308 may be further shaped to facilitate a rapid discharge of fluid when the collection vessel 303 is in a fluid discharge position. Fluid can pass out of the apparatus through a drain positioned along the bottom surface surrounded by the splash enclosure 304.

FIG. 3B is a side profile cross-sectional schematic representation of a precipitation gauge measurement assembly 300 as shown in FIG. 3 in a collection and measurement position. The weight gauge frame 316 is oriented to have the horizontal support tab 318 resting on top of and aligned with the load cell 306. In such embodiments, there is a space that separates the weight gauge frame 316 from directly resting on the upper ridge of the splash enclosure 304. In this configuration, any compressive and/or tensile force corresponding to an increase of fluid weight to the collection arm 308 will transmit to the load cells 306, and any portion of the force lost by being transmitted into the splash enclosure 304 will be minimized. In many embodiments, the weight gauge frame 316 has vertical support tabs 330 having holes which are aligned with holes in support rod mounts 332, and are configured to have a weighing support rod 334 extend and pass through both sets of holes. The weighing support rod 334 can serve the dual purpose of supporting the weight gauge frame 316 above the upper ridge surface of the splash enclosure 304 and providing an axis of rotation around which the measurement assembly weight gauge 302 can turn in order to transfer a portion of the fluid's weight to the load cell 306 while maintaining the alignment of the frame 302 with the load cell 306. It can also provide access to the splash enclosure interior volume 301 or a drain beneath the splash enclosure 304. In embodiments, the collection arm 308 can have a bucket, cup, U-shape, V-shape, or spoon shape where the bottom-most depth of the collection arm 308 is on about the same horizontal plane as the magnet 322. FIG. 3B further illustrates the location of the center of gravity of the collection vessel 303 when in the collection and measurement position and empty of fluid (“CG_{E}”) 350a, which is biased toward the resistance arm 310 side of the collection vessel 303, relative to the rotation axis defined by the pivot shaft 314.

FIG. 3C is a side profile cross-sectional schematic representation of a precipitation gauge measurement assembly 300 as shown in FIG. 3 in a fluid discharge position. As illustrated, an amount of fluid had collected in the collection arm 308 of the collection vessel 303 such that the collection arm torque pushing downward on the collection arm 308 overcame the resistance arm torque. The rotation tabs 320 of the collection vessel 303 allowed the collection vessel 303 to rotate around the pivot shaft 314. Accordingly, the collection vessel 303 is shown as rotated to a fluid discharge position, where the collection arm 308 is angled such that any fluid held within the collection arm is discharged into the splash enclosure interior volume 301. The splash enclosure 304 is configured completely surround the collection arm 308 when in a fluid discharge position in order to prevent any fluid exiting the collection arm 308 from splashing onto or falling into other elements of the measurement assembly 300 or collection station in which the measurement assembly is housed. In the fluid discharge position, the resistance arm 310 and armature counterweight 312 are raised to a position distal from the magnet 322 and above the horizontal plane in which the weight gauge frame 316 is oriented. Once fluid is discharged from the collection arm 308, the weight of the resistance arm 310 and armature counterweight 312 generate the resistance arm torque that causes the collection vessel 303 to rotate back to a collection and measurement position. FIG. 3C further illustrates the location of the center of gravity of the collection vessel 303 when in the discharge position (“CG_{D}”) 350b, which is biased toward the resistance arm 310 side of the pivot, relative to the rotation axis defined by the pivot shaft 314. The CG_{D} 350b is, however, less biased toward the resistance arm 310 side of the collection vessel 303 in comparison to the CG_{E} 350a. In some aspects, the magnetic attraction between the magnetically coupled armature counterweight 312 and magnet 322 also contributes to the rotation of collection vessel 303 back to a collection and measurement position.

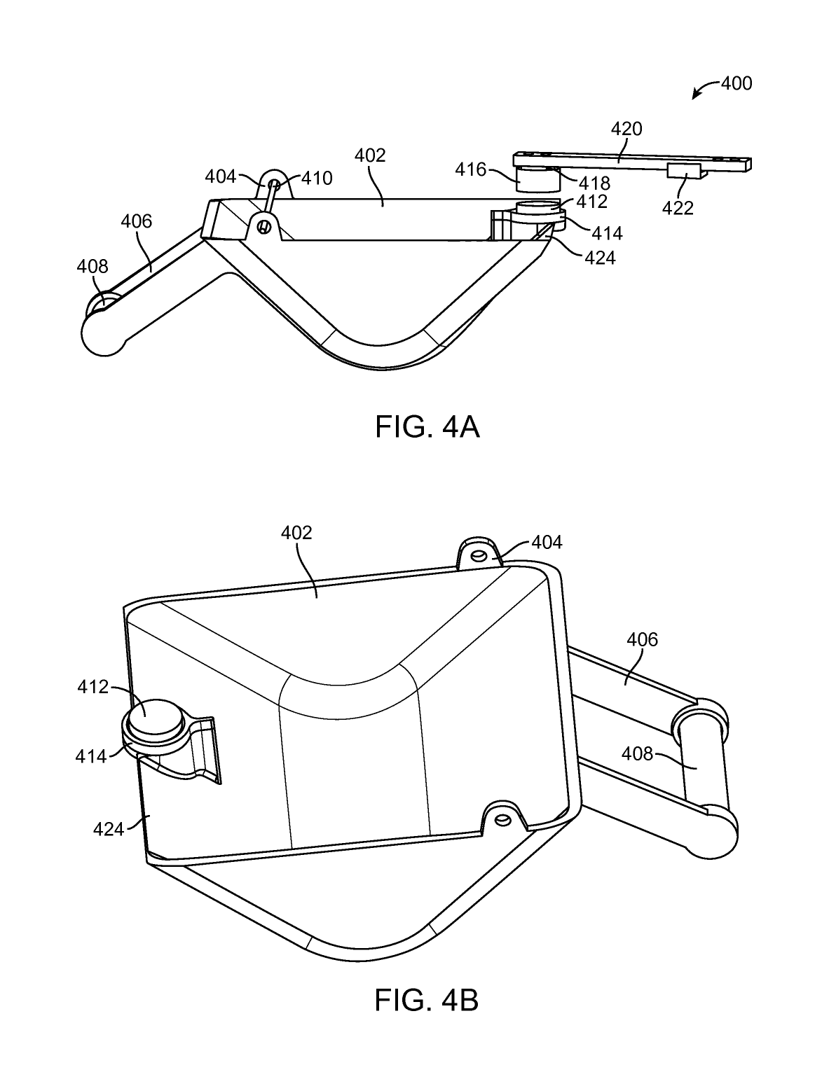

FIGS. 4A and 4B are perspective schematic representations of a precipitation gauge collection vessel 400 and sensor that can be utilized in embodiments of the presently-disclosed device, e.g. coupled to a pivot mount via a pivot shaft, coupled to a base adaptor, or coupled to a gauge frame via a pivot shaft. In such embodiments, the collection vessel of the precipitation weight gauge measurement assembly may be configured to have a magnet located on the collection arm side of the collection vessel. In some aspects or embodiments, the collection vessel 400 can be mounted within a weight gauge frame over a splash enclosure similar to those described in above embodiments. In other aspects or embodiments, the collection vessel 400 can be mounted on a base adaptor positioned one a base assembly similar to those described herein. The collection vessel 400 can include a collection arm 402, rotation tabs 404, a resistance arm 406, a counterweight 408, and a pivot shaft 410 where the axis of the pivot shaft 410 constitutes the center of rotation of the collection vessel 400. In such embodiments, a magnet 412 can be located at the end of the collection arm 402 distal from the rotation tabs 404, supported within a magnet base 416 molded or coupled to the pour lip 424 of the collection arm 402. The magnet 412 is configured along the pour lip 424 of the collection arm 402 to align with an armature 416, held or suspended above the magnet 412 and above the collection arm 402. As illustrated the armature can be coupled to a force gauge 420, suspended in proximity to and/or extending over the collection vessel 400. The force gauge 420 can be a cantilever beam gauge, held above the collection vessel 400 by a cantilever mount 422, which is attached to a frame or housing for the overall measurement assembly. In embodiments, the pour lip 424 can be molded or shaped to accommodate and/or reduce the turbulence of the flow of fluid around the magnet base 416, but still provide for the rapid discharge of fluid from the collection arm 402 when in a fluid discharge position.

In such embodiments, the collection arm 402 is positioned to collect fluid from above the measurement assembly. The collection vessel is held in a collection and measurement position by the weight of the counterweight 408 and attractive magnetic force between the magnet 412 and armature 416. In embodiments, the armature 416 and magnet 412 can be in physical contact with each other when the collection vessel 400 is in a collection and measurement position, and are shaped to be flush against each other as the magnetic attraction holds the armature 416 and magnet 412 together. In other embodiments, the armature 416 and magnet 412 can simply be in close proximity to each other when the collection vessel 400 is in a collection and measurement position. The force gauge 420 is connected to a microprocessor (not shown) which records signals from the force gauge 420. The magnet 412 on the distal end of the collection arm 402 can be in physical contact and/or close proximity with the armature 416 such that any vibration, tension, compression, or other change in force resulting from the addition of fluid to the collection arm 402 is transmitted through the magnet 412 and armature 416, and is sensed by the force gauge 420. The force gauge 420 accordingly detects the tension and/or compression caused by the weight of the water in the collection arm. Thus, the force gauge 420 detects increases in the weight of the fluid held in the collection arm 402 as the fluid is collected. Accordingly, in some embodiments, a cushion 418 may be located below the force gauge 420 between the armature 416 and the force gauge 420 to prevent and shock or trauma on the force gauge 420 resulting from the collection arm 402 and coupled magnet 412 moving too far, or over-travelling, in a direction toward the force gauge 420.

Further, as fluid accumulates in the collection arm 402, the weight of the fluid adds to the collection arm torque pushing the collection arm 402 downward around the center of rotation defined by the pivot shaft 410. The weight of the counterweight 408 and the magnetic attraction between the magnet 412 and the armature 416 generate a resistance arm torque in the direction opposite to the collection arm torque. As in other embodiments, the resistance arm torque operates to hold the collection vessel in a collection and measurement position, while the collection arm torque operates to move the collection vessel to a fluid discharge position.

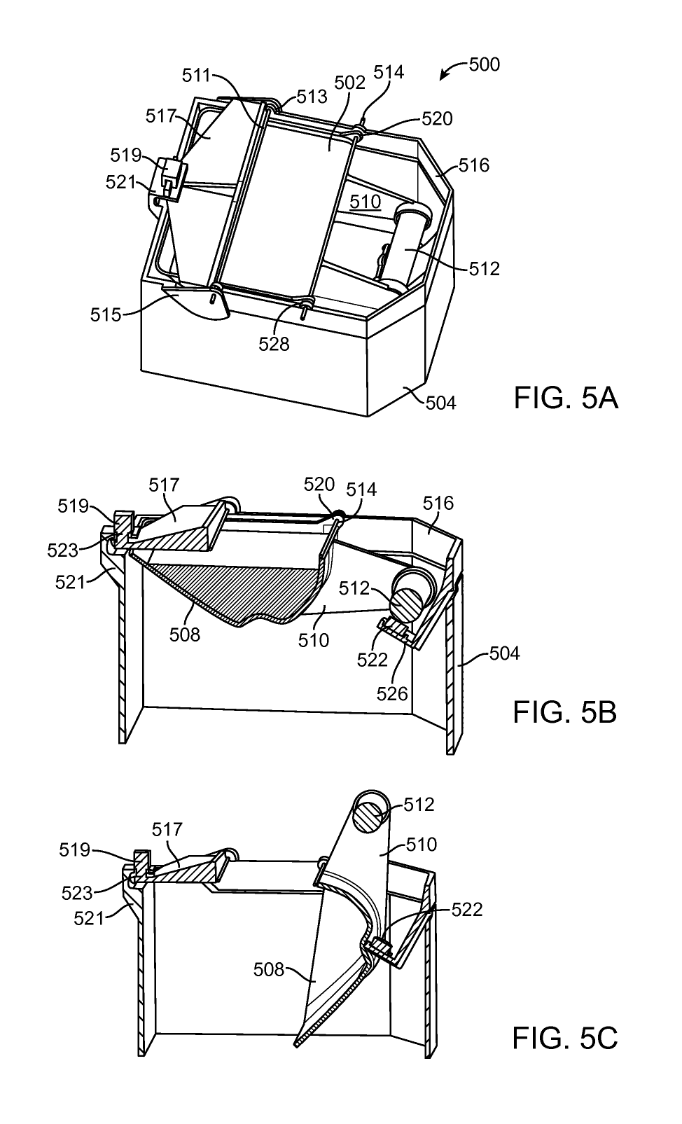

FIG. 5A is a perspective schematic representation of a precipitation weight gauge collection vessel and related sensor 500, having a collection vessel coupled to a gauge frame via a pivot shaft. FIG. 5B is a side profile cross-sectional schematic representation of a precipitation weight gauge collection vessel as shown in FIG. 5A, having the collection vessel in a collection and measurement position. FIG. 5C is a side profile cross-sectional schematic representation of a precipitation weight gauge collection vessel as shown in FIG. 5A, having the collection vessel in a discharge position. The precipitation gauge collection vessel 500 can be housed within a rain gauge collection station, and be accordingly positioned beneath a collection cone and delivery port which directs precipitation fluid into the precipitation gauge collection vessel 500. In particular, FIGS. 5A, 5B, and 5C illustrate an embodiment where the collection vessel 502 rests slightly above a splash enclosure 504, supported by a weight gauge frame 516. The weight gauge frame 516 is at least in part supported over the perimeter of the splash enclosure 504 by a support shaft 511. Rotation of the weight gauge frame 516 around the support shaft 511 is restrained by in part by (direct or indirect) contact between the forward cover 517 and the load cell 519. The precipitation weight gauge collection vessel and related sensor 500 can be housed within a rain gauge collection station, and be accordingly positioned beneath a collection cone and delivery port which directs precipitation fluid into the precipitation weight gauge collection vessel and related sensor 500. In such embodiments, the weight gauge frame 516 includes a collection arm 508, a resistance arm 510, an armature counterweight 512, and a tipping rotation tab 520. In such embodiments, the collection vessel 502 is suspended by a pivot shaft 514 which extends through holes in rotation tabs 520, and which further extends through holes, or into a cavity, of mounting tabs 528 which are part of the weight gauge frame 516. The mounting tabs 528 can extend from an upper surface of the weight gauge frame 516. Thus, the collection vessel 502 can rotate (i.e. pivot or tip) around the axis defined by the length of the pivot shaft 514. The collection arm 508 is positioned on one side of the tipping rotation tabs 520 and pivot shaft 514 while the resistance arm 510 is positioned on the opposing side of the tipping rotation tabs 520 and pivot shaft 514. The pivot shaft 514 can be generally cylindrical, such that it can freely rotate within receiving cavities or holes within the tipping rotation tabs 520 and mounting tabs 528.

In embodiments as illustrated, the weight gauge frame 516 is suspended by a support shaft 511 which extends through holes in weighing rotation tabs 513 and weighing rotation mounts 515. The weight gauge frame 516 can include magnet frame 526, which can project in a direction downward from the plane in which the weight gauge frame 516 is oriented. The magnet frame 526 can further be configured to carry and support a magnet 522. The armature counterweight 512 mounted at the end of the resistance arm 510 distal from the tipping rotation tabs 520 can be a steel element, or any other ferrous component, and can magnetically couple with the magnet 522. The attractive magnetic force between the armature counterweight 512 and the magnet 522 generates a resistance arm torque that provides resistance to any mechanical force acting on the armature counterweight 512 pulling the armature counterweight 512 in a direction away from the magnet 522. The resistance arm torque thus operates to hold the collection vessel 502 in a position where the collection arm 508 collects and holds any fluid that drops into the collection arm 508. Fluid that drops into the collection arm 508 causes the weight gauge frame 516 to rotate around the axis of the weighing support shaft 511, which can cause a projection tip 523 to apply increased force upward, toward a force sensor 519. As more fluid is collected, the weight of the fluid increases the collection arm torque acting on the collection vessel 502, pushing the collection arm 508 portion downward into the interior volume of the splash enclosure 504. When the collection arm torque is sufficient to overcome the resistance arm torque, the collection vessel 502 will rotate around the pivot shaft 514 to a fluid discharge position, as shown in FIG. 5C. In other words, due to the collection of fluid, the collection arm torque can overcome a threshold force, exceeding the resistance arm torque, at which point the collection vessel 502 can rotate around the axis of rotation defined by the pivot shaft 514.

The weight gauge frame 516 can further include the forward cover 517 that extends over and covers at least a portion of the collection arm 508 and provides rigidity to the weight gauge frame 516. In some aspects, the forward cover can prevent loss of fluid held in the collection arm due to splashing or other mechanical agitation of the collection vessel 502. In some aspects, the forward cover 517 can be shaped to have a flat or converging front end which can be configured to come into contact with the force sensor 519. In other aspects, the forward cover 517 can include the projection tip 523 which can directly contact and transmit force to the force sensor 519. The force sensor 519 can be supported on a mounting structure 521 extending from the splash enclosure 504. In particular, the force sensor 519 can detect increments of weight increase as the collection arm 508 collects fluid. When the collection vessel 502 tips and empties fluid held by the collection arm 508, the weight gauge frame 516 can return to a balanced position about the axis of the weighing support rod 511, exerting an amount of force through the projection tip 523 onto the force sensor 519 indicative of an empty collection arm 508, thereby allowing the force sensor 519 to reset and assume a zero value in order to again begin measuring increments of weight. In aspects, the force sensor 519 can also measure the force generated by the armature counterweight 512 contacting the magnet 522 when the collection vessel 502 rotates back to the collection position.

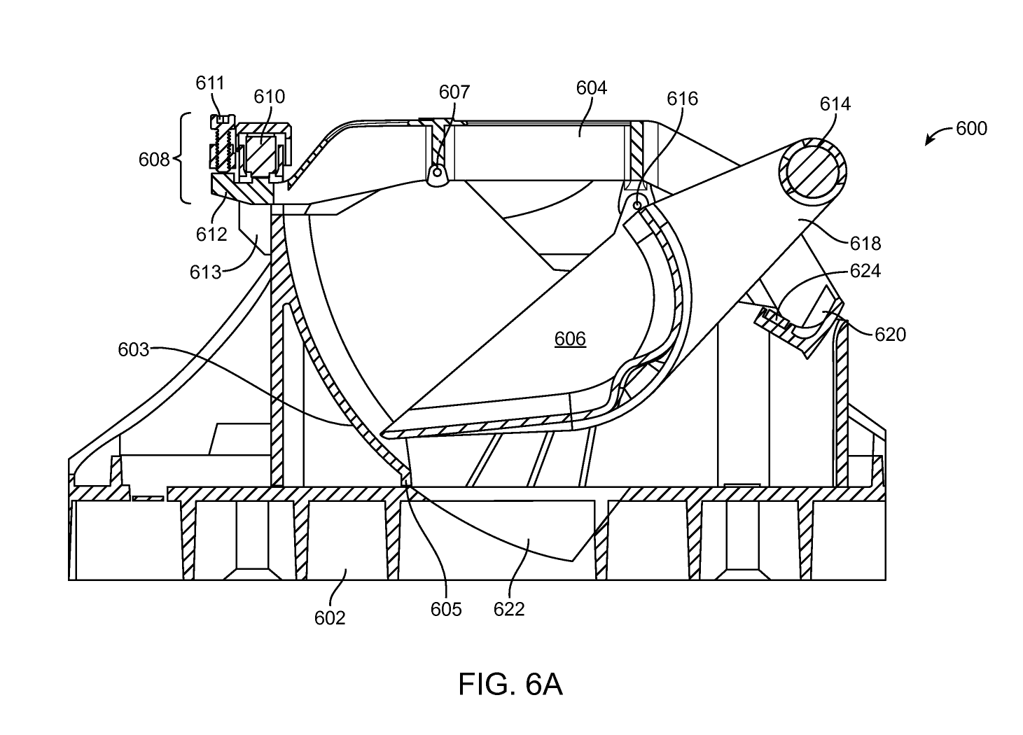

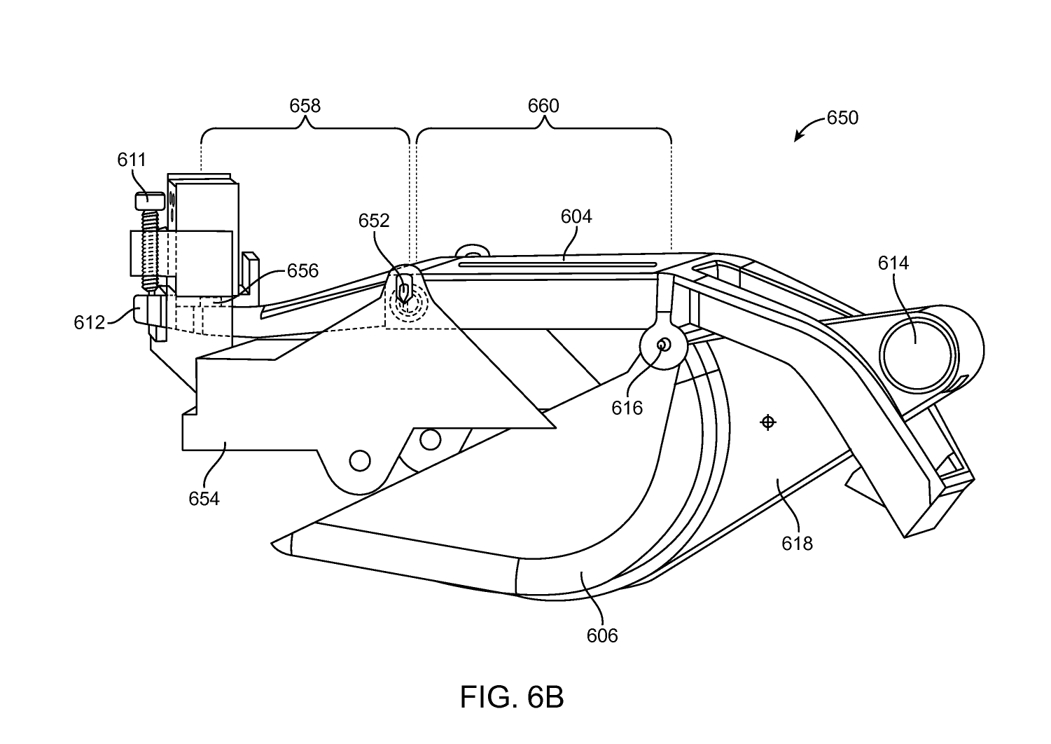

FIG. 6A is a side profile cross-sectional schematic representation of a precipitation weight gauge measurement assembly 600, in between a collection and measurement position and a fluid discharge position. A collection vessel base 602 can, as in embodiments described above, include a splash enclosure structure to prevent splashing of collected water. The precipitation weight gauge measurement assembly 600 can be housed within a rain gauge collection station, and be accordingly positioned beneath a collection cone and delivery port which directs precipitation fluid into the precipitation weight gauge measurement assembly 600. In the embodiment illustrated in FIG. 6A, the splash enclosure further includes a curved ramp 603 that conforms to the path of the collection arm 606, suspended by a support frame 604, as the collection arm 606 rotates from a collection and measurement position to a fluid discharge position. The curved ramp 603 can be cylindrical in shape, and can function to retain water in the collection arm 606 until the collection arm moves past the base point 605 of the curved ramp 603 and the collection arm 606 is in the fluid discharge position. In other words, until the tip of the collection arm 606 rotates past the base point 605 of the curved ramp 603, fluid collected is held in a splash enclosure space defined by the collection arm 606, the side of the curved ramp 603 facing the collection arm, and lateral walls of the collection vessel base 602 on either side of the collection arm 606. The structure of the curved ramp 603 in combination with the rotation path of the collection arm 606 provides for a steep tip angle, such that when the weight of the water carries the tip of the collection arm 606 past the base point 605 of the curved ramp 603, the steep tip angle ensures that the discharge of fluid from the collection arm 606 is complete, discharging all, or almost all, fluid held in the collection arm 606.

Further illustrated in FIG. 6A are an armature counterweight 614 mounted at the end of a resistance arm 618, located in opposition to the collection arm 606, which rotate around a pivot mount 616. The support frame 604 includes a portion configured to be a magnet frame 620 that can be configured to carry and support a magnet 624 that can magnetically couple with the armature counterweight 614. In aspects, the weight gauge measurement assembly can include a sensor assembly 608, which can include at least a sensor mounting structure 613, a projection tip 612, and a force sensor 610, similar to embodiments as described above. In aspects, the sensor assembly 608 can further include a limit screw 611 that can be set to define a maximum range of motion for the projection tip 613 as the support frame 604 rotates around the axis of a weighing support rod 607.

FIG. 6B is a perspective schematic representation of a precipitation weight gauge measurement assembly 650. In aspects, a precipitation weight gauge measurement assembly 650 as illustrated in FIG. 6B can suspend a support frame 604 by use of weighing pivots 652 positioned within holes in an upper base portion 654 of a splash enclosure or other base structure. On one end of the support frame 604 is a load pad 656 which can presses against the load cell 610, which in turn is mounted on or fixed to the upper base portion 654. Attached to the support frame 604 is a magnet (not shown) which magnetically couples with the armature counterweight 614 and thereby latches the collection arm 606 when in an “empty” rotational position.

The collection arm 606, resistance arm 618, and armature counterweight 614 collectively hang from the support frame 604, attached at two pivot points by the pivot mount 616. As noted in other embodiments, when the collection arm 608 is empty, the collection arm 608 is held in a substantially horizontal position by two forces, the weight of the armature counterweight 614 and the attractive magnetic force between the armature counterweight 614 and the magnet supported by the support frame 604. The collective weight of the collection arm 606, resistance arm 618, and armature counterweight 614, as well as the weight of the support frame 604 itself, cause a rotational force on the support frame 604 about the weighing pivots 652. In aspects, the weighing pivots 652 can have an edge (optionally referred to as “knife-edged”) so as to provide for a minimum-friction, minimum-stiction bearing for transfer of weight to the load cell 610. The weight of the support frame 604 and rotation is counteracted by the force exerted by the load cell 610 on the support frame 604 via the load pad 656. The load cell force 610 causes generation of an electrical signal by the load cell 610, the amplitude of that signal providing for a measure of the weight of the support frame 604, collection arm 606, resistance arm 618, and armature counterweight 614.

As liquid is collected in the collection arm 606, the increases of weight cause increases the amplitude of the load cell 610 output signal. These incremental increases are a measure of the liquid collecting in the collection arm 606. During a given collection period, the signal increments are monitored by a microcomputer in the control circuitry and reported as output signals indicating increments of rainfall. Increments of precipitation that can be detected and measured can be about 0.01″ of rainfall, 0.1 mm of rainfall, or both. Other data, such as rate of rainfall, can also be detected and reported.

FIG. 6B further illustrates the relationship between the measure arm 658 and the load arm 660 defined by the tipping pivot and weighing pivot locations along the overall support frame 604. The measure arm 658 is defined as the distance from the weighing pivots 652 to the point of contact with the load cell 610. The load arm 660 is defined as the distance from the weighing pivots 652 to the tipping pivots, i.e. the axis defined by the pivot points at the pivot mount 616. The ratio of these two arm lengths determines a multiplier which affects the force exerted on the load cell 610 by a given weight on the load arm 660. As the ratio of load arm length 660 to measure arm length 658 (i.e. LOAD ARM/MEASURE ARM) is increased, the force on the load cell 610 for a given weight of liquid in the collection arm 606 is increased. In aspects, the ratio, and resultant force, can be adjusted by moving the location of the weighing pivots 652 to positions either more distal or more proximate to the tipping pivots. Accordingly, the configuration of the balance scale can set this multiplier so as to maximize the full range of any given load cell 610. In such aspects, the contact surface of the load cell 610 can be at the same elevation as the axis where the weighing pivots 652 contact the upper base portion 654, thereby ensuring that the force on the load cell 610 is normal (perpendicular) to the load cell 610.

As in other embodiments, as the weight of collected liquid increases, the rotational force about the tipping pivot (i.e. pivot mount 616) increases the force tending to pull an armature counterweight 614 away from a magnet. When the force of the weight exceeds the retention force of the magnetic field, the collection arm 606 and resistance arm 618 assembly will be released to rotate about the tipping pivot axis, and dump the collected liquid. In some aspects, the weight exceeding the retention force can be about 180 grams of collected precipitation, which is approximately equivalent to about one-third (⅓″) of an inch of rainfall. Similarly, when the collection arm 606 has emptied, the weight of the armature counterweight 614 causes rotation of the collection arm 606 and resistance arm 618 back to a horizontal collection position, and the detecting of incremental weight increases is resumed. In aspects, a microprocessor or computer can perform an auto-zeroing or re-zeroing after each dump of fluid, such that only positive increments of weight are recorded. Accordingly, no errors result from water remaining in the collection 606 arm after a dump of liquid, or from evaporation between rainfall events.

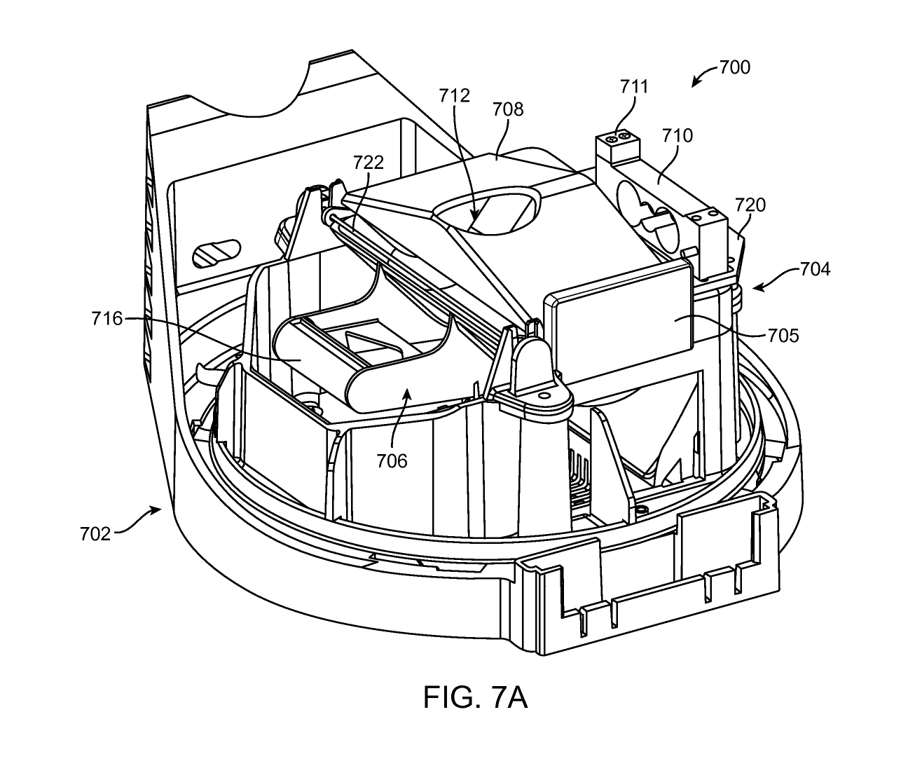

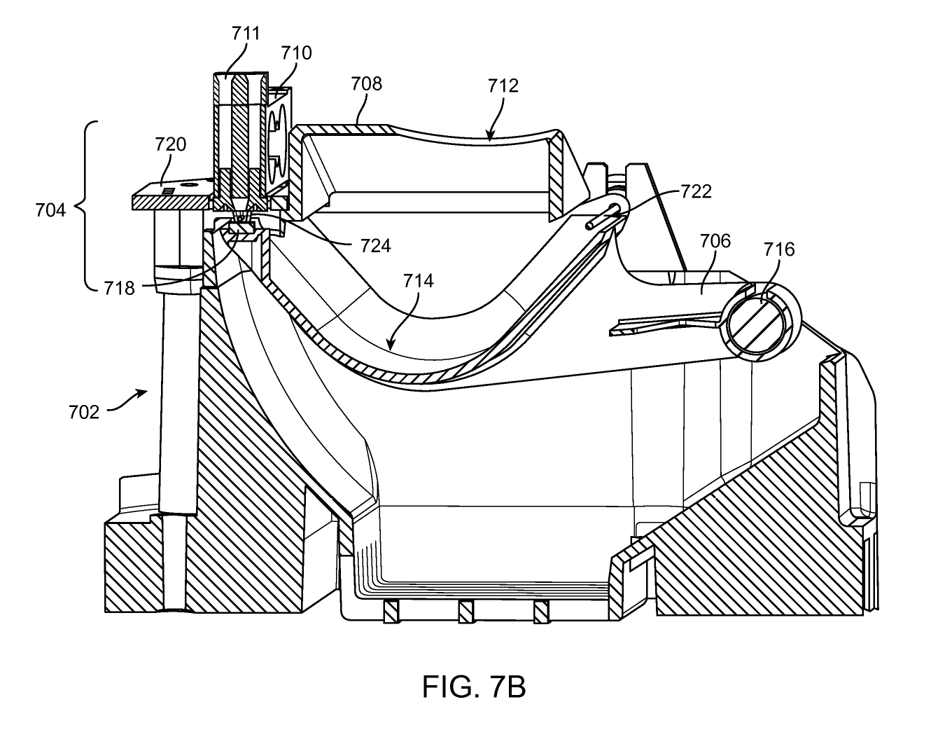

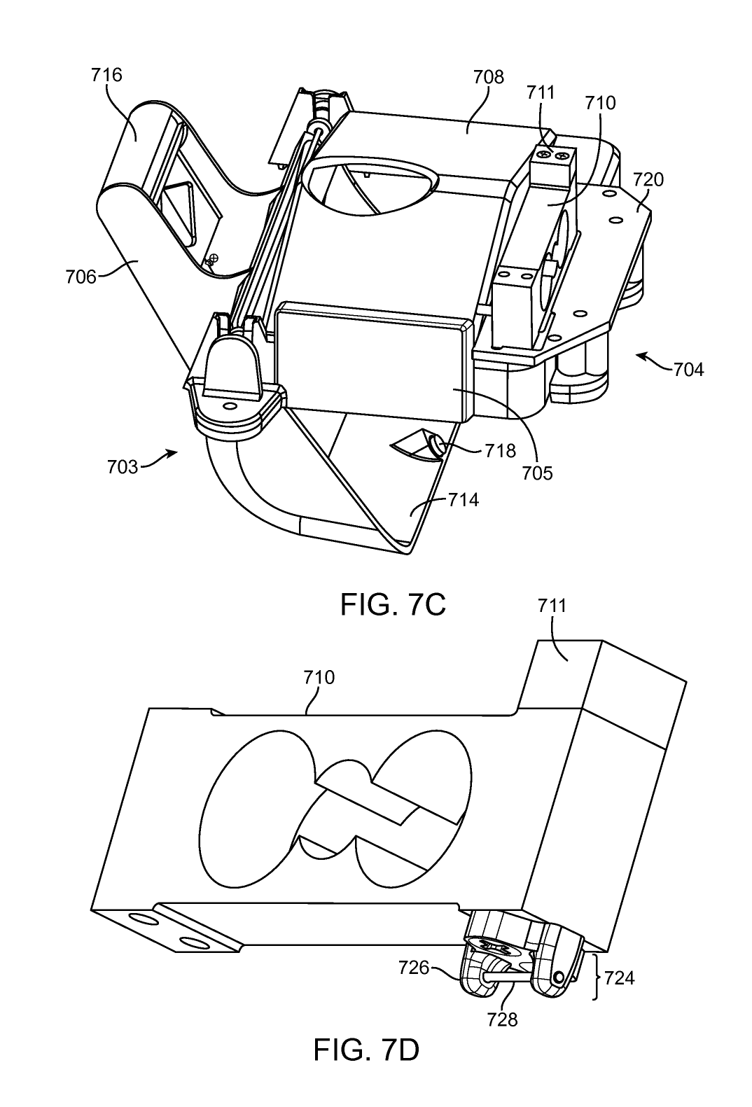

FIG. 7A is a perspective view representation of a precipitation weight gauge measurement assembly 700, having a collection vessel 703 mounted on a base adaptor 704, where the collection vessel 703 is in a collection and measurement position. FIG. 7B is a cross-sectional schematic representation of a precipitation weight gauge measurement assembly 700, having a collection vessel 703 (as seen in FIG. 7C) mounted on a base adaptor 704 in a collection and measurement position. The precipitation gauge measurement assembly 700 can be housed within a rain gauge collection station, and be accordingly positioned beneath a collection cone and delivery port which directs precipitation fluid into the precipitation gauge measurement assembly 700, where the precipitation is collected in the collection arm 714. The base assembly 702 can be a molded and articulated part constructed to support the base adaptor 704 and to have a drain located below the collection vessel 703 mounted to the base adaptor 704. The base adaptor 704 can include one or more securing points where the base adaptor 704 can be secured to the base assembly 702. The base adapter 704 and the base assembly 702 provide a curved surface which closely tracks the path of the tip of the collection arm 714 tip as it rotates, maintaining a small space between the tip of the collection arm 714 and the curved surface. This curved surface retains much of the fluid within the collection arm 714 as the collection arm 714 rotates, such that the fluid continues to provide momentum to the rotation and carries the collection arm 714 to the full-discharge position before the fluid is released.

The base adaptor can further include a module 705 that can house a circuit board containing a microprocessor and other interface electronics for communicating with non-transitory computer-readable mediums coupled to the precipitation gauge measurement assembly 700. In some aspects, the securing points can be threaded apertures for screws to secure the base adaptor 704 to the base assembly 702. The base adaptor can further include an adaptor roof 708 constructed to span the width of the base adaptor 704 and, in some aspects, provide structural strength and rigidity to the base adaptor 704. The adaptor roof 708 can further include a passage 712 through which precipitation can pass through, so as to fall into the collection vessel 703. In further aspects, the adaptor roof 708 can in part prevent fluid that falls into the collection arm 714 from splashing or scattering outside of the space defined between the collection arm 714 and the adaptor roof 708.

The collection vessel 703 can include a collection arm 714 and a counterweight arm 706, where the counterweight arm 706 is configured to hold a counterweight 716. In some aspects, the counterweight arm 706 can be molded to have an articulated beam extending across the width of the collection vessel 703 and connecting two extensions forming part of the counterweight arm 706. The articulated beam of the counterweight arm 706 can provide for structural strength and rigidity to the counterweight arm 706, and can further be molded to have spaces or openings so as to have the counterweight arm 706 meet a target weight. The collection vessel 703 is mounted to the base adaptor 704 via a pivot rod 722, where the collection vessel 703 can rotate around the axis defined by the pivot rod 722. The pivot rod 722 can be supported by rotation tabs that are part of the structure of the base adaptor 704, where the collection vessel 703 is suspended on the pivot rod 722 such that the collection vessel 703 can rotate around the axis defined by the length of the pivot rod 722. The collection arm 714 and counterweight arm 706 of the collection vessel 703 hang from the base adaptor 704, attached at two pivot points via the pivot rod 722. The pivot rod 722 can be generally cylindrical, such that it can freely rotate within receiving cavities or holes within the rotation tabs of the base adaptor 704.

Similar to other embodiments herein, when the collection arm 714 is empty, the collection vessel 703 is held in a substantially horizontal position by two forces, the weight of the counterweight 716 and the attractive magnetic force between the magnet 718 and the armature unit 724, which is attached to a load cell 710 such that force exerted upon the armature unit 724 is sensed by the load cell 710. The counterweight 716 applies a force that urges the collection vessel 703 toward the collection and measurement position where the counterweight arm 706 is urged downward at least in part by the weight of the counterweight such that the collection arm 714 of the collection vessel is urged upward toward the plane of the base adaptor. In some aspects, the base assembly 702 can have a curved ramp positioned along the rotation path of the collection arm 714. The curved ramp can be cylindrical in shape and can function to retain water in the collection arm 714 until the collection arm moves past a base point of the curved ramp and the collection vessel 703 is in the fluid discharge position. The structure of the curved ramp in combination with the rotation path of the collection arm 714 provides for a steep tip angle, such that when the weight of the water carries the tip of the collection arm 714 past the base point of the curved ramp, the steep tip angle ensures that the discharge of fluid from the collection arm 714 is complete, discharging all, or almost all, fluid held in the collection arm 714.

The base adaptor 704 is further configured to support the load cell 710 located proximate to the tip of the collection arm 714, when the collection vessel 703 is in a collection and measurement position. The load cell 710 can be further supported on a support plate 720, where either or both of the load call 710 and the support plate 720 can be constructed of a metal such as aluminum. The load cell 710 and support plate 720 can be machined to mechanically couple with each other, such that the load cell 710 has an area within or equal to the perimeter of the support plate 720. In some aspects, the support plate 720 prevents the load cell 710 from over-extending or over-stressing in a downward direction due to the strain from the weight of the collection vessel 703 and fluid held within the collection arm 714, applying force on the load cell 710 through the magnet 718 and armature unit 724 or any other external force. In further aspects, the load cell 710 can rest on top of and be coupled to the support plate 720. In other aspects, the load cell 710 can fit into and mechanically couple with a recess of the support plate 720.

As seen in FIG. 7B, the tip of the collection arm 714 of the collection vessel 703 has a magnet 718 that can magnetically couple with an armature unit 724. The armature unit 724 is coupled to the load cell 710 and can be a metallic element that the magnet 718 magnetically couples to such that, when fluid collects in the collection arm 714 in the collection and measurement position, the force of such fluid is measured by the load cell 710 through additional downward strain on the armature unit 724. As the collection arm 714 collects more fluid from precipitation, the moment of the collection vessel 703 about the pivot rod 722 increases on the collection arm 714 side of the collection vessel 703, increasing the collection arm torque acting on the collection vessel 703, and pushing the collection arm 714 portion downward into the interior volume of the base assembly 702. Further, as the collection arm 714 collects fluid, the strain and/or tensile force resulting from the increased weight is transmitted through the collection vessel 703, through the armature unit 724, to the load cell 710 which transmits a signal that can be measured and used to calculate the increase of fluid. When the weight of the fluid in the collection arm 714 provides a torque on the collection vessel 703 sufficient to overcome the combined downward force of the counterweight arm 706 and the force of the magnetic coupling between the magnet 718 and the armature unit 724, the collection vessel 703 rotates around the pivot rod 722 to a fluid discharge position allowing fluid to empty out of the collection arm and pass out through the drain in the base assembly 702. In other words, due to the collection of fluid, the collection arm torque can overcome a threshold force, exceeding the resistance arm torque, at which point the collection vessel 703 can rotate around the axis of rotation defined by the pivot rod 722.

FIG. 7C is a perspective view representation of a collection vessel 703 mounted on a base adaptor 704 as shown in FIG. 7A, in a fluid discharge position. The collection arm 714 of the collection vessel can, in some aspects, hold an amount of rainfall or other precipitation of about 0.15″, or about 4 mm, in depth. In terms of volume, the collection arm 714 can hold a volume of rainfall or other precipitation of about sixty-five to ninety milliliters (65 mL-90 mL). In some embodiments, the collection arm 714 can hold a volume of up to about two hundred milliliters (200 mL) or more. In further embodiments, the collection arm 714 can hold a volume of rainfall or other precipitation of about one hundred eighty (180 mL). In particular embodiments, the collection arm 714 may hold a volume of up to about two hundred twenty milliliters (220 mL) while being configured to tip once the volume in the collection arm 714 reaches about one hundred eighty milliliters (180 mL). In various embodiments, the collection arm 714 can hold a volume of fluid greater than or less than the volume and ranges considered above. The collection arm 714 may be further shaped to facilitate a rapid discharge of fluid when the collection vessel 703 is in a fluid discharge position. Fluid can pass out of the apparatus through a drain in the base assembly 702.

As liquid is collected in the collection arm 703, the increases in weight cause increases in the amplitude of the load cell 710 output signal. These incremental increases are a measure of the liquid collecting in the collection arm 703. During a given collection period, the signal increments are monitored by a microcomputer in the control circuitry and reported as output signals indicating increments of rainfall. Increments of precipitation that can be detected and measured can be about 0.01″ of rainfall, 0.1 mm of rainfall, or less. Other data, such as rate of rainfall, can also be detected and reported.

FIG. 7D is a perspective view representation of a load cell 710 and armature unit 724 for a precipitation weight gauge measurement assembly having a base adaptor, as shown in FIG. 7A. In some aspects, the armature 728 can be a wire while in other aspects the armature 728 can be a thin metallic band. In such aspects, the armature 728 can be shaped such that the magnet 718 couples equally and consistently independent of small variations of the angle of the collection arm 703. The armature 728 can be supported within an armature housing 726, thereby forming the armature unit 724. In aspects, the armature housing 726 can be a plastic or polymer structure which can in part enclose and/or suspend the armature 728.

Optionally, as shown in FIGS. 7A-7D, a preload weight 711 can be attached to the load cell 710. A constant downward force is exerted by the preload weight 711 on the load cell 710, where the preload weight 711 is located such that the constant downward force opposes and counteracts the upward force exerted by the magnet 718 when the collection arm 714 is empty of fluid. Accordingly, the load cell 710 experiences only a single polarity of force as the collection arm 714 increasingly fills with fluid.

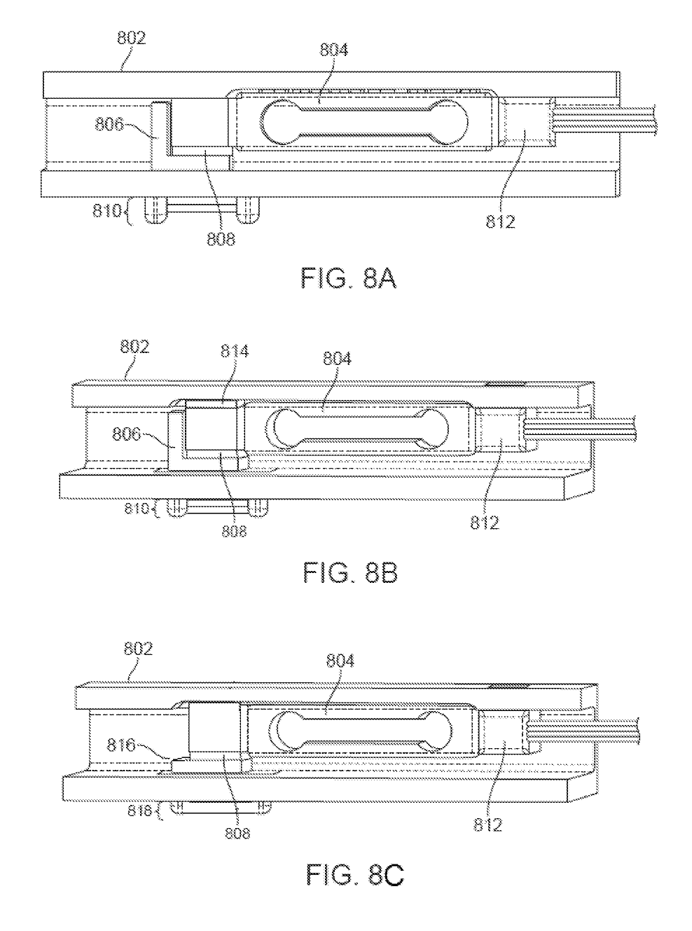

FIG. 8A is a side cross-sectional view of an exemplary mounting of a load cell 804 to a support plate 802 for a collection vessel. In contrast to other embodiments of the present disclosure, the load cell 804 may be used, rather than a flat panel, as mounted to a section of a channel in a support plate 802. The load cell 804 is secured to the “ceiling” of the channel, with an L-shaped pre-load weight 806 and an armature fixture 810 attached on the opposite side of the channel. A first cushioning pad 808 is disposed between and attached to the load cell 804 and the L-shaped pre-load weight 806. FIG. 8B is a side cross-sectional view of an alternative exemplary mounting of the load cell 804 to a support plate 802 for a collection vessel. In the embodiment shown in FIG. 8B, a second cushioning pad 814 is further disposed between the channel ceiling and the top surface of the load cell 804, and can be attached to either of the channel in the support plate 802 or the load cell 804. Neither the first cushioning pad 808 nor the second cushioning pad 814 is under compression when the a coupled collection vessel is in a collection position. A sensory relay 812 can transmits signals from the load cell 804 to electronically coupled non-transitory computer-readable mediums.

As in other embodiments, the magnet on the a collection arm lip is held to the armature fixture 810 as the collection arm collects water. The collection arm is released when the weight of the water overcomes the magnet field's retentive force; the collection arm then tips. When the collection arm returns to the collection position, either or both of the first cushioning pad 808 and the second cushioning pad 814 acts as a cushion to absorb a portion of the shock and vibration caused by the impact of the collection arm magnet on the armature fixture 810. Moreover, the ceiling of the channel in the support plate 802 prevents excessive upward movement of the load cell 804 past horizontal.

FIG. 8C is a side cross-sectional view of a further alternative exemplary mounting of the load cell 804 to a support plate 802 for a collection vessel. In the embodiment shown in FIG. 8C, load cell 804 is secured to a planar pre-load weight 816, which is coupled to the support plate 802 with a securing structure 818. In this embodiment, the load cell 804 is attached to the support plate 802 in such a manner that the support plate 802 itself prevents any reverse excursion of the load cell 804. The planar pre-load weight 816 performs the function and replaces the need for an armature fixture or holder.

In many aspects, the data measured by load cells in embodiments of the present disclosure can be representative of the weight of fluid in a collection vessel, a precipitation rate, a precipitation intensity, electrical signals analogous to clicks of a tipping bucket as the collection vessel collects fluid, and variations and combinations thereof. In other aspects, load cells as disclosed herein can be machined metal components, cut to allow for flexibility in the metal structure, and coupled with one or more wires to a differential amplifier, further connected to a non-transitory computer readable medium that is local to the rain gauge and/or remote from the rain gauge. In further aspects, data from a load cell can be continuously transmitted to a non-transitory computer readable medium through wired or wireless communication elements. In yet further aspects, data from a load cell can be transmitted or read in increments or batches to a non-transitory computer readable medium.

Further alternative embodiments of the precipitation weight gauge measurement assemblies discussed above can be configured to transpose the positions of the magnet and armature and/or armature counterweight. In other words, in embodiments of the measurement assemblies, each paired magnet and armature can be swapped in terms of how and where the magnet and armature are mechanically coupled to the structure of the measurement assembly.

As provided herein, the force gauge and/or load cells which sense compressive and/or tensile forces are electronically coupled with non-transitory computer readable mediums, such as microprocessors or processors connected for transmission to the Internet. A force gauge and/or load cell can be electrically coupled to a microprocessor (or equivalent) by wires or by wireless means and thereby send sensory signals to the microprocessor. The coupled microprocessor which collects the sensory data from the force gauge and/or load cell can further relay sensed information to other non-transitory computer readable mediums, and/or run calculations on collected data and relay the calculated result to a user-operable and/or user-readable display. The signals detected by the force gauge and/or load cells can be filtered by the microprocessor (either through hardware or software) to base calculations only on signals that indicate positive increment of weight or force.

As provided herein, the collection vessel can be considered a lever, where the fulcrum of the lever is positioned at the rotation section and pivot mount (i.e. at the middle of the lever), between the collection arm and the resistance arm; thus the collection vessel can be considered a Class 1 lever. In such embodiments, the resistance on the lever, the torque that acts on a collection vessel toward a collection and measurement position, is provided by the magnetic coupling of the magnet and the armature and/or armature counterweight and the weight of the counterweight. Conversely, the effort force on the lever, the torque that acts on a collection vessel toward a fluid discharge position, is primarily provided by the weight of the fluid F held in the collection arm. However, in alternative embodiments, the fulcrum of the lever may be positioned at an end of the lever, such that either the effort torque or the resistance torque may be located in the middle of the lever; i.e. as a Class 2 or a Class 3 lever, respectively.

The above description is illustrative and is not restrictive, and as it will become apparent to those skilled in the art upon review of the disclosure, that the present invention may be embodied in other specific forms without departing from the essential characteristics thereof. Further, throughout the foregoing description, for the purposes of explanation, numerous specific details were set forth in order to provide a thorough understanding of the invention. It will be apparent, however, to persons skilled in the art that these embodiments may be practiced without some of these specific details. These other embodiments are intended to be included within the spirit and scope of the present invention. Accordingly, the scope of the invention should, therefore, be determined not with reference to the above description, but instead should be determined with reference to the following and pending claims along with their full scope of legal equivalents.

What is claimed is:

1. A precipitation gauge comprising:
a base assembly;
a base adaptor, coupled to the base assembly;
a collection vessel having a collection arm and a counterweight arm configured to receive fluid in the collection arm, mounted to the base adaptor via a pivot rod, and operable between a collection and measurement position and a fluid discharge position;
a magnet located on the collection arm;
an armature configured to magnetically couple to the magnet and hold the collection vessel in the collection and measurement position; and
a load cell electrically coupled to the armature and configured to transmit signals corresponding to tension on the armature.

2. The precipitation gauge of claim 1, wherein the collection arm is configured to collect fluid where the collection vessel is oriented at the collection and measurement position, and wherein an increase in weight of the collection vessel due to the collected fluid increases tension on the armature.

3. The precipitation gauge of claim 1, wherein where the weight of the collection arm and fluid held in the collection arm exerts a torque around the pivot rod greater than a combination of an opposing torque the counterweight arm exerts around the pivot rod and an attractive force of the magnetic coupling between the armature and magnet, the collection vessel rotates around a rotational axis of the pivot rod to the fluid discharge position.

4. The precipitation gauge of claim 1, wherein where the torque the counterweight arm exerts around the pivot rod is greater than the torque the collection arm collection arm exerts around the pivot, the collection vessel rotates around a rotational axis of the pivot rod to the collection and measurement position.

5. The precipitation gauge of claim 1, further comprising a housing above and around the base assembly and the base adaptor, configured to receive precipitation and direct fluid into the collection vessel.

6. The precipitation gauge of claim 5, further comprising a debris filter mounted within the housing configured to prevent detritus from falling onto the precipitation gauge.

7. The precipitation gauge of claim 5, wherein the housing has an opening configured to have a shape and area to regulate the amount of precipitation directed toward the collection vessel.

8. The precipitation gauge of claim 1, further comprising a non-transitory computer-readable medium electrically connected with the load cell configured to receive, store, and transmit data corresponding to the signals transmitted by the load cell.

9. The precipitation gauge of claim 1, wherein the load cell transmits signals proportional to increases in tension on the armature, the increase in tension on the armature generated by increases in weight due to fluid collected in the collection arm to which the armature is magnetically coupled via the magnet.

10. The precipitation gauge of claim 1, wherein the collection arm has a symmetrical shape such that a center of mass of the fluid contained in the collection arm moves in a vertical direction, and a moment arm length of a mass of the fluid about the pivot rod remains constant as the collection arm fills with fluid.

11. The precipitation gauge of claim 1, wherein the base adaptor has a curved surface retains that tracks the path of the tip of the collection arm tip as it rotates, such that as the collection arm fills with fluid, the fluid provides momentum to the rotation and carries the collection arm to a full-discharge position before the fluid is released.

12. A method of measuring precipitation comprising:
collecting precipitation in a collection vessel in a collection and measurement position;
sensing a tensile force caused by the weight of precipitation collected with at least one load cell coupled to the collection vessel;
correlating the tensile force sensed by the at least one load cell with a precipitation measurement;
discharging precipitation collected in the collection vessel once a threshold volume of precipitation has been collected by pivoting the collection vessel to a fluid discharge position; and
returning the collection vessel to the collection and measurement position.

13. The method according to claim 12, wherein correlating the tensile force sensed by the at least one load cell comprises sensing positive increments in weight.

14. The method according to claim 12, wherein correlating the tensile force sensed by the at least one load cell comprises not sensing negative increments in weight.

15. The method according to claim 12, wherein the at least one load cell is coupled to an armature, wherein the armature is configured to magnetically couple with a magnet on a collection arm of the collection vessel, and wherein precipitation collected in the collection arm increases tension on the at least one load cell via the armature magnetically coupled to the magnet.

16. The method according to claim 12, wherein the collection vessel is positioned within a housing, the housing having an opening with a shape and an area regulating the amount of precipitation collected by the collection vessel.

17. The method according to claim 12, wherein the at least one load cell relays data corresponding to the weight of precipitation to a microprocessor to calculate a precipitation measurement.

18. The method according to claim 12, wherein a counterweight arm of the collection vessel provides a torque urging the collection vessel toward the collection and measurement position.

19. The method according to claim 12, wherein precipitation discharged from the collection vessel is directed toward a drain positioned below the collection vessel.

20. The method according to claim 17, wherein after discharging precipitation collected in the collection vessel, the microprocessor re-zeroes the weight of precipitation in the collection vessel.
